(19) United States
(12) Patent Application Publication
(10) Pub. No.: US 2015/0344689 A1
(43) Pub. Date: Dec. 3, 2015

(54) THERMOPLASTIC POLYAMIDE COMPONENTS, AND COMPOSITIONS AND METHODS FOR THEIR PRODUCTION AND INSTALLATION

(71) Applicant: INVISTA TECHNOLOGIES S.A.R.L., St. Gallen (CH)

(72) Inventors: Vikram GOPAL, Wichita, KS (US); Rajeev S. BHATIA, Hixson, TN (US); Mark ELKOVITCH, Signal Mountain, TN (US); Chul S. LEE, Andover, KS (US)

(73) Assignee: INVISTA NORTH AMERICA S.A.R.L., Wilmington, DE (US)

(21) Appl. No.: 14/653,639

(22) PCT Filed: Dec. 17, 2013
(86) PCT No.: PCT/US2013/075800

§ 371 Date: Jun. 18, 2015

Related U.S. Application Data
(60) Provisional application No. 61/739,402, filed on Dec. 19, 2012.
(60) Provisional application No. 61/824,051, filed on May 16, 2013.
(60) Provisional application No. 61/831,860, filed on Jun. 6, 2013.

(51) Int. Cl. C08L 77/06; B29C 47/08; F16L 9/128; B29C 47/00; F16L 9/00; F16L 9/12

(52) U.S. Cl. CPC C08L 77/06; F16L 9/006; F16L 9/12; F16L 9/128; B29C 47/0026; B29C 47/0059; B29C 47/0855; C08L 2207/04; C08L 2203/18; B29K 2077/00

(57) ABSTRACT

Thermoplastic polyamide containing components, as well as compositions, articles of manufacture, and methods for their production and installation are provided.

This patent application claims the benefit of priority for U.S. Provisional Application Ser. No. 61/831,860, filed Jun. 6, 2013, U.S. Provisional Application Ser. No. 61/824,051 filed May 16, 2013 and U.S. Provisional Application Ser. No. 61/739,402 filed Dec. 19, 2012, the contents of each of which are herein incorporated by reference in their entirety.

### FIELD OF THE INVENTION

This disclosure relates to thermoplastic polyamide containing components, as well as compositions, articles of manufacture, and methods for the production and installation of such components.

### BACKGROUND OF THE INVENTION

High pressure pipe systems are used to transfer oil and gas from their source to refineries, to transport hydrocarbon containing fluids, for water transportation in fracking, in water systems for residential and commercial facilities and/or for transport of compatible chemicals. Traditionally, such pipelines, especially when used to transfer oil and gas from their source to refineries, have been made from steel. While steel pipelines have acceptable pressure ratings for these uses and relatively low production costs, they are very expensive to transport and to install and are susceptible to corrosion, thus requiring corrosion protection. For this reason, there has been a transition to use of alternative materials for pipelines.

Polyethylene pipes and fittings have been in use for oil and gas distribution since the 1970s. They present an advantage to steel pipelines because they are coilable, corrosion free and provide a leak-free method of transporting fluids. However, polyethylene pipes can generally only be used at pressures below 10 bars.

Further, while reinforcing materials can be used to increase their pressure limits, this can be a very costly process that may require multiple layers of pipe or pipes wrapped with reinforcing materials.

Additional materials used in production of pipes include polyamide-11, polyamide-12, polyamide 6,12, and polyvinylidene difluoride (PVDF). Due to the relative low tensile strength, such pipes often need to be reinforced for use in the field.

Evonik Degussa has disclosed a polyamide 12 (PA12) pipe VESTAMID® NRG for use by the gas distribution energy.

UBESTA Polyamide 12 has also been disclosed as a plastic pipe system developed for the gas industry for both burial and for rehabilitation of existing cast iron and steel gas mains.

Coiled Polyamide 11 high pressure gas pipes at diameters up to 2 inches have also been disclosed by Arkema.

In addition, DuPont has disclosed PIPELON®, a polyamide 6,12 piping system for use in the oil and gas industry requiring a plasticizer. PIPELON® is used most frequently as a liner for high performance piping, not as a standalone pipe.

It is still highly desirable, however, to use alternative polyamides with a higher tensile strength than HDPE, polyamide 11 and PVDF, for pipeline construction.

However, previous attempts at making pipeline from, for example, Nylon 6,6 have been unsuccessful and resulted in poor quality pipes. This is because the manufacturing of pipeline made using extrusion or blow molding requires the base polymer or polyamide to have a very high melt viscosity and high molecular weight.

Further Nylon 6,6 and Nylon 6 have been disclosed to be more susceptible and/or sensitive to stress cracking (Margolis J. M. “Engineering Thermoplastics—Properties and Applications”, Marcel Dekker, Inc. 1985, New York and Basel, page 117).

### SUMMARY OF THE INVENTION

There is a need for extruded polyamide pipes that meet the performance standards needed for use in oil and gas transport. There is also a need for a process to extrude thermoplastic pipes from starting thermoplastic materials with relatively low melt viscosities.

The present invention relates to polyamide containing compositions, articles of manufacture and methods for production and use of such compositions as thermoplastic polyamide containing components.

Accordingly, a first aspect of the present invention relates to polyamide containing compositions. Compositions of the present invention comprise 60 to 99.9% by weight of a polyamide and 0.5 to 40% by weight of an impact modifier containing maleic anhydride or a functional equivalent thereof. In these compositions, the moisture level is less than the equilibrium moisture content of the polyamide.

Another aspect of the present invention relates to an article of manufacture comprising at least one component formed from a composition comprising 60 to 99.9% by weight of a polyamide with a moisture level less than the equilibrium moisture content of the polyamide and 0.5 to 40% by weight of an impact modifier containing maleic anhydride or a functional equivalent thereof.

Another aspect of the present invention relates to a pipe comprising at least one component formed from a composition comprising 60 to 99.9% by weight of a polyamide with a moisture level less than the equilibrium moisture content of the polyamide and 0.5 to 40% by weight of an impact modifier containing maleic anhydride or a functional equivalent thereof. In one nonlimiting embodiment, the pipe produced from the compositions and methods of the present invention maintains a uniform ovality throughout its length and achieves a quick burst stress of at least 4000 psi when fully saturated with water, a quick burst stress of at least 6000 psi without saturation, a long term hydrostatic strength (LTHS) of at least 1000 psi at 82° C., a LTHS of at least 2000 psi at 23° C. and/or a pressure design basis for a 3″ standard dimension ratio (SDR) 11 pipe of at least 400 psig.

Another aspect of the present invention relates to extrudable polyamide containing thermoplastic resins. In one nonlimiting embodiment, the extrudable thermoplastic resin has a melt strength of at least 0.08N and comprises 60 to 99.9% by weight of a polyamide and 0.5 to 40% by weight of an impact modifier. In another nonlimiting embodiment, the extrudable thermoplastic resin comprises 60 to 99.9% by weight of a polyamide and 0.5 to 40% by weight of an impact modifier and is capable of forming a pipe. Examples of uses for pipes formed from this embodiment of extrudable thermoplastic resin include, but are not limited to, oil and gas pipeline, for transporting hydrocarbon containing fluids, water transportation in fracking, water systems for residential and commercial facilities and/or transport of compatible chemicals. In another nonlimiting embodiment, the extrudable thermoplastic resin comprises a polyamide and has a shear viscosity from 500 to 3000 Pa-sec when tested at a shear rate of 50 sec⁻¹ and a melt temperature of 270-280° C., and a moisture level from 0.03 to 0.15%.

Another aspect of the present invention relates to pipes extruded from the compositions or extrudable polyamide containing thermoplastic resins of the present invention. In one nonlimiting embodiment, a pipe of the present invention is extruded from a composition comprising 60 to 99.9% by weight of a polyamide and 0.5 to 40% by weight of an impact modifier containing maleic anhydride or a functional equivalent thereof with a moisture level less than the equilibrium moisture content of the polyamide. In another nonlimiting embodiment, a pipe of the present invention is extruded from a thermoplastic resin comprising 60 to 99.9% by weight of a polyamide and 0.5 to 40% by weight of an impact modifier. In another nonlimiting embodiment, a pipe of the present invention is extruded from a polyamide containing thermoplastic resin having a melt strength of at least 0.08N and comprising 60 to 99.9% by weight of a polyamide and 0.5 to 40% by weight of an impact modifier. In another nonlimiting embodiment, a pipe of the present invention is extruded from a thermoplastic resin comprising a polyamide and having a shear viscosity from 500 to 3000 Pa-sec when tested at a shear rate of 50 sec⁻¹ and a melt temperature of 270-280° C., and a moisture level from 0.03 to 0.15%.

Another aspect of the present invention relates to extruded thermoplastic pipes comprising a polyamide. In one nonlimiting embodiment of the present invention, the extruded thermoplastic pipe has a quick burst stress of at least 4000 psi when fully saturated with water. In another nonlimiting embodiment of the present invention, the extruded thermoplastic pipe has a quick burst stress without saturating the pipe of at least 6000 psi. In another nonlimiting embodiment of the present invention, the extruded thermoplastic pipe has a LTHS of at least 1000 psi at 82° C. In another nonlimiting embodiment of the present invention, the extruded thermoplastic pipe has a LTHS of at least 2000 psi at 23° C. In another nonlimiting embodiment of the present invention, the extruded thermoplastic pipe is a 3″ SDR11 pipe and exhibits a pressure design basis of at least 400 psig. In another nonlimiting embodiment of the present invention, the extruded thermoplastic pipe has a shear relative viscosity below 1000 Pa-sec when tested at a shear rate of 50 sec⁻¹ and a melt temperature of 270-280° C., and a moisture level from 0.03 to 0.15%. In another nonlimiting embodiment of the present invention, the extruded thermoplastic pipe has an SDR from about 3 to about 30. In another nonlimiting embodiment of the present invention, the extruded thermoplastic pipe is made with a swell ratio ranging from 0.5 to 2.5. In another nonlimiting embodiment of the present invention, the extruded thermoplastic pipe is made in a die having an orientation ratio ranging from 2 to 30.

Another aspect of the present invention relates to extruded thermoplastic pipes comprising a polyamide, wherein at least a portion of an outer surface of the pipe is covered by a reinforcing material.

Another aspect of the present invention relates to extruded thermoplastic pipes comprising a polyamide, wherein at least a portion of an inner surface of the pipe and/or an outer surface of the pipe is bonded with a second thermoplastic material.

Another aspect of the present invention relates to extruded thermoplastic pipes comprising a polyamide, wherein at least a portion of an inner surface of the pipe and/or an outer surface of the pipe is covered by an unbonded second thermoplastic material.

Another aspect of the present invention relates to compositions, thermoplastic resins and pipes of the present invention further comprising a silicone based additive.

Another aspect of the present invention relates to pipes of the present invention which are capable of being butt fused with another thermoplastic pipe of the same composition.

Another aspect of the present invention relates to pipes of the present invention which are capable of being coupled with another pipe through electrofusion, compression fitting and/or transition fitting.

Another aspect of the present invention relates to extruded thermoplastic pipes comprising a polyamide and which maintain their ovality and can be coiled for transport and storage.

Another aspect of the present invention relates to a process for extruding a thermoplastic pipe. In this process, a melted polyamide containing thermoplastic resin with a moisture level of the polyamide less than the equilibrium moisture content of the polyamide is extruded and passed through a pipe forming zone of an extrusion apparatus to form the thermoplastic pipe.

Another aspect of the present invention relates to an article of manufacture comprising a coiled pipe extruded from a polyamide containing thermoplastic resin.

Yet another aspect of the present invention relates to a process for coiling an extruded thermoplastic polyamide pipe. In this process, the extruded thermoplastic polyamide pipe is coiled with a coiling strain less than the yield strain of the composition in use. In one embodiment, the coiling strain is designed to be about 1% to about 30%, more preferably from about 3% to about 6%.

### BRIEF DESCRIPTION OF THE FIGURES

FIG. 1 is an illustrative view of a thermoplastic pipe of the present invention.

FIG. 2 is a chart showing the time to failure as function of hoop stress for a thermoplastic pipe for the present invention.

FIG. 3 is a chart showing the time to failure as function of test pressure for a thermoplastic pipe of 3″ nominal diameter and with an SDR equal to 11, for the present invention.

FIG. 4A through 4G are photographs of pipes showing the effect of maleation on the inside surface. FIGS. 4A-4C shows the inside surface of a pipe of the present invention prepared from nylon 6,6 having an initial relative viscosity of at least 48 at effective maleation levels of 0.11, 0.165 and greater than 0.165% respectively. FIGS. 4D and 4E show the inside surface of a pipe of the present invention prepared from nylon 6,6 having an initial relative viscosity of at least 80 at effective maleation levels of 0.08 and 0.165% respectively. FIGS. 4F and 4G shows the inside surface of a pipe of the present invention prepared from nylon 6,6 having an initial relative viscosity of at least 240 at effective maleation levels of 0.11 and 0.165% respectively.

### DETAILED DESCRIPTION OF THE INVENTION

This present invention provides thermoplastic polyamide containing pipes, as well as compositions, articles of manufacture and methods for their production and installation.

Compositions of the present comprise 60 to 99.9% by weight of a polyamide. In one embodiment, the polyamide is a high tensile strength polyamide. By “high tensile strength” for purposes of the present invention, it is meant the maximum stress that a material can withstand while being stretched or pulled before failing or breaking. For high tensile strength polyamides such as nylons, the tensile strength typically ranges between about 20 and about 200 MPa across typical temperature ranges of operation. Preferred is that the high tensile strength polyamide exhibit a tensile strength upon 100% saturation with water of greater than 20 MPa at 23° C. Examples of high tensile strength polyamides for use in these compositions include, but are not limited to nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof. By “combinations thereof” with respect to polyamides, it is meant to include, but is not limited to, block copolymers, random copolymers, terpolymers, as well as melt blends.

In the compositions of the present invention, the moisture level is decreased to less than the equilibrium moisture content of the polyamide. It has now been found that melt strength and melt quality of the composition and components produced from the compositions are significantly improved when the moisture content of the polyamide is maintained below the equilibrium moisture content of the polyamide. At higher moisture content levels, melt fracture, low melt stability, poor appearance and other undesirable surface defects were observed. For purposes of the present invention, by “equilibrium moisture content”, it is meant the level of moisture in a selected polyamide in a molten phase which allows the molecular weight of the selected polyamide to remain stable and not degrade for a period of time required to process it. Thus, in one nonlimiting embodiment of the composition of the present invention, the polyamide is nylon 6,6 having an initial relative viscosity of at least 35. In this embodiment, the moisture level of the composition is decreased to less than the equilibrium moisture content of nylon 6,6 of 0.15% by weight. In another nonlimiting embodiment of the composition of the present invention, the polyamide is nylon 6,6 having an initial relative viscosity of at least 48. In this embodiment, the moisture level of the composition is decreased to 0.05% by weight or less. In another nonlimiting embodiment of the composition of the present invention, the polyamide is nylon 6,6, having an initial relative viscosity of at least 80. In this embodiment, the moisture level is decreased to 0.03% by weight or less. In yet another nonlimiting embodiment of the composition of the present invention, the polyamide is nylon 6,6 having an initial relative viscosity of at least 240. In this embodiment, the moisture level is decreased to 0.005% by weight or less.

Compositions of the present invention further comprise 0.5 to 40% by weight of an impact modifier. Suitable impact modifiers for use in the present invention include those known in the art that impart improved impact strength when combined with polyamide resins. U.S. Pat. Nos. 4,346,194, 6,579,581 and 7,671,127, herein incorporated by reference, teach nylon resins with impact modifying components.

In one embodiment of the compositions of the present invention, the impact modifier contains maleic anhydride or a functional equivalent thereof. For impact modifiers containing maleic anhydride, it is preferred that the impact modifier has an effective maleic anhydride level of less than 1% by weight. More preferred is that the impact modifier has an effective maleic anhydride level of 0.044 to 0.11% by weight.

The “effective maleic anhydride level”, for purposes of the present invention is calculated based upon the amount of maleic anhydride containing impact modifier added to the composition and the maleation level of the selected impact modifier. Thus, as a nonlimiting example, a 100 gram portion of a composition of the present invention comprising 78 grams of polyamide and 22 grams of impact modifier having a maleation level ranging from 0.2% to 0.5% will have an effective maleic anhydride level of 0.044% to 0.11%. As will be understood by the skilled artisan upon reading this disclosure, the amount of impact modifier added to the composition is adjusted based upon its maleation level so that the effective maleic anhydride level is preferably less than 1% by weight.

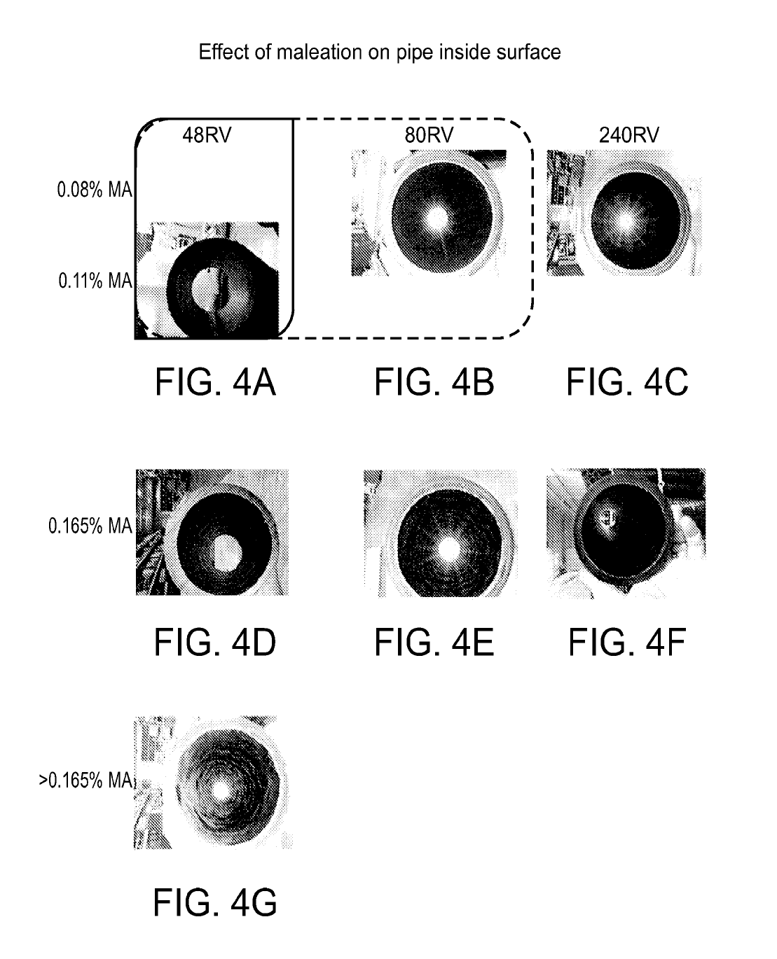

Photographs of pipes showing the effect of various maleation levels on the inside pipe surface of pipes comprised of nylon 6,6 having an initial relative viscosity of at least 48, 80 or 240 are depicted in FIGS. 4A through 4G. As shown therein, the inner surface of a pipe comprised of nylon 6,6 having an initial relative viscosity of 48 remained smooth at effective maleation levels between 0.11% and 0.165%. See FIGS. 4A and 4B. The inner surface of pipes comprised of nylon 6,6 having an initial relative viscosity of 80 and nylon 6,6 having an initial relative viscosity of 240 were also smooth at an effective maleation level of 0.08%. See FIGS. 4D and 4F.

Examples of commercially available impact modifiers containing maleic anhydride which can be used in the present invention include, but are not limited to: Amplify™ GR216, a maleic anhydride polyolefin elastomer sold by Dow®; Lotader® 4700, a random terpolymer of ethylene, ethyl acrylate and maleic anhydride, and Oervac® IM300, a maleic anhydride modified low-density polyethylene, each sold by Arkema®l; Exxelor™ VA 1840, a semi-crystalline ethylene copolymer functionalized with maleic anhydride sold by ExxonMobil®.

In one embodiment of the composition of the present invention, the impact modifier comprises a maleated ethylene propylene diene rubber.

By “functional equivalents” with respect to the impact modifier, it is meant to include impact modifiers, which upon reading this disclosure, would be understood by those skilled in the art, to provide impact modifying characteristics to polyamides similar to the above impact modifiers containing maleic anhydride.

Suitable elastomers for the impact modifier include, but are not limited to, polymers or copolymers of ethylene, propylene, octene with alkyl acrylate or alkyl methacrylate. Other suitable elastomers for the impact modifier include, but are not limited to, styrene-butadiene two-block copolymers (SB), styrene-butadiene-styrene three-block copolymers (SBS), and hydrogenated styrene-ethene/butene-styrene three-block copolymers (SEBS). Other elastomers that may be used in the impact modifiers include terpolymers of ethylene, of propylene, and of a diene (EPDM rubber).

The impact modifier further comprises a functional group such as, but not limited to, a carboxylic acid group, a carboxylic anhydride group, a carboxamide group, a carboximide group, an amino group, a hydroxyl group, an epoxy group, a urethane groups or an oxazoline groups. In one embodiment, the impact modifier comprises an elastomeric polyolefinic polymer functionalized with an unsaturated carboxylic anhydride. In this embodiment, preferred is that the impact modifier has an unsaturated carboxylic anhydride content in the range from 0.2 to about 0.6 by weight percent.

As will be understood by the skilled artisan upon reading this disclosure, as different polyamides and copolyamides which can be used in the present invention each have their own associated equilibrium moisture content, in order to obtain the desired melt strength and viscoelastic behaviors described herein, effective maleation levels and moisture content may need to balanced in percentages which may vary from the specific ranges disclosed herein. These variations in effective maleation level and/or moisture content for the different polyamides and copolyamides disclosed herein to arrive at the desired melt strength and viscoelastic behaviors described herein are encompassed by the present invention.

The composition of the present invention may further comprise a heat stabilizer and/or colorant.

Suitable heat stabilizers include, but are not limited to hindered phenols, amine antioxidants, hindered amine light stabilizers (HALS), aryl amines, phosphorus based antioxidants, copper heat stabilizers, polyhydric alcohols, tripentaerythritol, dipentaerythritol, pentaerythritol and combinations thereof. In one embodiment, the amount of heat stabilizer added to the compositions ranges from about 0.004 to about 5% by weight. In one nonlimiting embodiment, the heat stabilizer is Cu—Hs and is added in an amount up to 200 ppm. In another nonlimiting embodiment, an antioxidant such as Irganox or Irgaphos is added to provide processing stability.

Colorant can be added to increases resistance to ultraviolet light and to prevent wear of pipes and other components formed from the compositions. Suitable colorants include, but are not limited to, carbon black and nigrosine. In one embodiment, colorant concentrate in a range of about 0.01 to about 9% by weight percent is added to increase the UV resistance and prevent wear of the thermoplastic pipe or other component. In this embodiment, colorant level of the pipe typically ranges from about 0.01 to 2.5%.

Examples of additional additives which can also be included in the compositions of the present invention include, but not limited to, lubricants, mineral fillers, pigments, dyes, antioxidants, hydrolysis stabilizers, nucleating agents, flame retardants, blowing agents and combinations thereof. Suitable mineral fillers include, but are not limited to, kaolin, clay, talc, and wollastonite, diatominte, titanium dioxide, mica, amorphous silica, glass beads, glass fibers and combinations thereof.

In some embodiments of the present invention, it may be further desirable to increase the melt viscosity of the thermoplastic composition by addition of 0.1 to 5%, more preferably 1% or less, of an olefin (ethylene, styrene, vinayl acetate)-maleic anhydride copolymer. Preferred is that the olefin and maleic anhydride copolymer having a molecular weight in the range of about 500 to about 400,000 g/mol. Suitable melt viscosity enhancers for use in the present invention include any such that are known in the art. In one nonlimiting embodiment, the olefin is ethylene. A commercially available 1:1 copolymer of ethylene-maleic anhydride is sold under the name ZeMac® by Vertellus®. A commercially available styrene-maleic anhydride copolymer is sold by Cray Valley.

In one embodiment of the present invention the composition further comprises a plasticizer.

In another embodiment, the composition does not further comprise or contain a plasticizer.

In one embodiment, the composition of the present invention is formed into a pellet to facilitate extrusion of pipes and other components from the compositions.

The compositions of the present invention can be used in articles of manufacture comprising at least one component formed from a composition of the present invention. Examples of components which can be formed from the compositions of the present invention include, but are not limited to, pipes, sheets, films, tapes, fibers, laminates, caps and closures, geomembranes and molded articles formed by processes including, but not limited to extrusion, co-extrusion, blow molding calendering, compression molding, injection molding, injection compression, thermoforming hot stamping and coating.

The compositions of the present invention can also be used in the formation of pipes comprising at least one component formed from a composition of the present invention.

The present invention also provides extrudable thermoplastic polyamide containing resins.

In one embodiment, the thermoplastic polyamide containing resin of the present invention has a melt strength of at least 0.08N, more preferably at least 0.12N. Melt strength refers to how strong the polyamide and/or resin is in a molten state and is essential to shaping of the polyamide and/or resin, based upon both hang strength and melt integrity, into the desired shape. For purposes of the present invention, melt strength is determined as the load at break.

In another embodiment, the thermoplastic polyamide containing resin of the present invention is capable of forming a pipe. In one embodiment, the pipe extruded from this resin is for oil and gas pipeline, for transporting hydrocarbon containing fluids, water transportation in fracking, water systems for residential and commercial facilities and/or transport of compatible chemicals. Accordingly, in this embodiment, it is preferred that the pipe extruded from this resin have a quick burst stress of at least 4000 psi when fully saturated, a quick burst stress of 6000 psi without saturation, a LTHS of at least 1000 psi at 82° C., a LTHS of at least 2000 psi at 23° C. and/or a pressure design basis for a 3″ SDR11 pipe of at least 400 psig.

In another embodiment, the thermoplastic polyamide containing resin of the present invention has a shear viscosity from 500 to 3000 Pa-sec when tested at a shear rate of 50 sec⁻¹ and a melt temperature of 270-280° C., and a moisture level from 0.03 to 0.15%. The shear viscosity of the resin at various shear rates is an indicator of the melt viscosity of the thermoplastic resin, an important characteristic to determine if the thermoplastic pipe can be extruded and formed to its desired shape.

The thermoplastic resins of the present invention comprise 60 to 99.9% by weight of a polyamide and 0.5 to 40% by weight of an impact modifier. It is preferred that the moisture level of the polyamide in the thermoplastic resins be less than the equilibrium moisture content of the polyamide. Also preferred is that the polyamide be a high tensile strength polyamide such as, but not limited to, nylon 6,6; nylon 6; nylon 4,6; nylon 6,12; nylon 6,10; nylon 6T; nylon 9T; nylon DT; nylon DI; nylon D6; and nylon 7; and/or combinations thereof.

Impact modifiers for use in these thermoplastic resins may comprise an elastomer such as, but not limited to, ethylene, propylene, octene with alkyl acrylate or alkyl methacrylate, styrene-butadiene two-block copolymers, styrene-butadiene-styrene three block copolymers, and copolymers or terpolymers of ethylene, octane, propylene and/or diene and/or a functional group such as, but not limited to, carboxylic acid groups, carboxylic anhydride groups, carboxamide groups, carboximide groups, amino groups, hydroxyl groups, epoxy groups, urethane groups and oxazoline groups.

In one embodiment, the impact modifier has an unsaturated carboxylic anhydride content in the range from 0.2 to 0.6% by weight.

In one embodiment, the impact modifier contains maleic anhydride and has an effective maleic anhydride level of less than 1% by weight, more preferably 0.044 to 0.11% by weight. Examples of commercially available impact modifiers containing maleic anhydride which can be used in this embodiment of present invention include, but are not limited to: Amplify™ GR216, a maleic anhydride polyolefin elastomer sold by Dow®; Lotader® 4700, a random terpolymer of ethylene, ethyl acrylate and maleic anhydride, and Oervac® IM300, a maleic anhydride modified low-density polyethylene, each sold by Arkema®l; Exxelor™ VA 1840, a semi-crystalline ethylene copolymer functionalized with maleic anhydride sold by ExxonMobil®.

In one embodiment, the impact modifier of the thermoplastic resin comprises a maleated ethylene propylene diene rubber.

The extrudable thermoplastic resins of the present invention may further comprise a silicon base additive. In one embodiment, the thermoplastic resin comprises 0.5 to 25% by weight of a silicon based additive. In one embodiment, the silicon based additive comprises an ultrahigh molecular weight siloxane polymer and a binding agent. Preferred is that the ultrahigh molecular weight siloxane polymer be unfunctionalized and non-reactive with the polyamide. Further preferred is that the unfunctionalized siloxane polymer not be considered as either a gel or an oil. Suitable binding agents for the silicone based additive include, but are not limited to fumed silica. In one embodiment, the silicone based additive is provided in a pelletized silicone gum formulation. A nonlimiting example of a commercially available formulation is sold under the name Genioplast® Pellet S by Wacker.

In one embodiment of the present invention, the resin further comprises a plasticizer.

In another embodiment, the resin does not further comprise or contain a plasticizer.

However, nonlimiting examples of additional additives which can be included in the resins of the present invention include lubricants, mineral fillers, pigments, dyes, antioxidants, hydrolysis stabilizers, nucleating agents, flame retardants, blowing agents and combinations thereof. Suitable mineral fillers include, but are not limited to, kaolin, clay, talc, and wollastonite, diatominte, titanium dioxide, mica, amorphous silica, glass beads, glass fibers and combinations thereof.

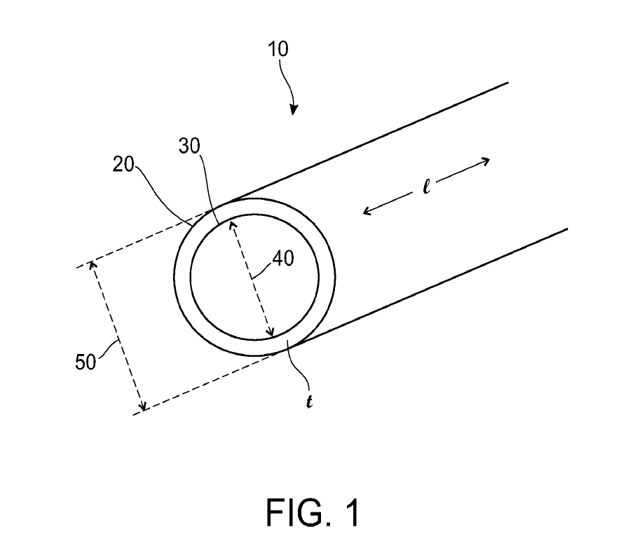

The present invention also provides pipes extruded from the compositions and thermoplastic resins of the present invention. FIG. 1 provides a diagram of a thermoplastic pipe 10 of the present invention having a length, l, and a wall of thickness, t, wherein the wall has an outer surface 20 and an inner surface 30, and wherein the outer surface defines an outer diameter 50 of the thermoplastic pipe and the inner surface defines an inner diameter 40 of the thermoplastic pipe.

In one embodiment, a pipe of the present invention is extruded from a composition comprising 60 to 99.9% by weight of a polyamide, wherein the moisture level of the composition is less than the equilibrium moisture content of the polyamide, and 0.5 to 40% by weight of an impact modifier containing maleic anhydride or a functional equivalent thereof. In another embodiment, a pipe of the present invention is extruded from an extrudable thermoplastic polyamide containing resin having a melt strength of at least 0.08N, more preferably at least 0.12N. In another embodiment, a pipe of the present invention is extruded from a thermoplastic polyamide containing resin capable of forming a pipe for oil and gas pipeline, for transporting hydrocarbon containing fluids, water transportation in fracking, water systems for residential and commercial facilities and/or transport of compatible chemicals. In this embodiment, the pipe of the present invention has a quick burst stress of at least 4000 psi when fully saturated, a quick burst stress of at least 6000 psi without saturation, a LTHS of at least 1000 psi at 82° C., a LTHS of at least 2000 psi at 23° C. and/or a pressure design basis for a 3″ SDR11 pipe of at least 400 psig. In another embodiment, a pipe of the present invention is extruded from a thermoplastic polyamide containing resin having a shear viscosity from 500 to 3000 Pa-sec when tested at a shear rate of 50 sec⁻¹ and a melt temperature of 270-280° C., and a moisture level from 0.03 to 0.15%.

The present invention also provides extruded thermoplastic pipe comprising a polyamide.

In one embodiment, the pipe of the present invention exhibits a quick burst stress without saturating the pipe of at least 6600, more preferably in the range of at least 7000 to 12,000 psi when tested at 23° C. More specifically, pipes of the present invention have been demonstrated to exhibit a burst stress of at least 4000 psi when fully saturated with water at 23° C. For a pipe with an SDR of 11, this corresponds to a burst pressure of at least 800 psi. Pipes of the present invention have been demonstrated to exhibit a burst stress of at least 7000 psi at 23° C. without saturating the pipe with water. For a pipe with an SDR of 11, this corresponds to a burst pressure of at least 1200 psi.

In another embodiment, the pipe of the present invention exhibits a LTHS of at least 1000 psi at 82° C. and/or a LTHS of at least 2000 at 23° C.

In another embodiment, a pipe of the present invention with an SDR of 11 exhibits a pressure design basis of at least 400 psig.

In another embodiment, the pipe of the present invention exhibits a shear relative viscosity below 1000 Pa-sec when tested at a shear rate of 50 sec⁻¹ and a melt temperature of 270-280° C., and a moisture level from 0.03 to 0.15%.

In another embodiment, the pipe of the present invention has a standard dimension ratio (SDR) from about 3 to about 30, more preferably from about 7 to about 25, more preferably from about 10 to about 12. The standard dimension ratio or SDR of the thermoplastic pipe is measured by dividing the outer diameter 50 by the wall thickness t. In one embodiment of the present invention, the outer diameter of the pipe ranges from about 1 inch to about 10 inches while the wall thickness ranges from about 0.03 to about 4 inches.

In another embodiment, the pipe of the present invention is made with a swell ratio ranging from 0.5 to 2.5, more preferably 0.7 to 1.3, and more preferably 0.7 to 1.2. For purposes of the present invention, by “swell ratio” it is meant the ratio of die gap to wall thickness of the pipe.

In another embodiment, the pipe of the present invention is made in a die having an orientation ratio ranging from 2 to 30, more preferably 5 to 25, more preferably 5 to 21. For purposes of the present invention, by “orientation ratio” it is meant the ratio of length of die to die gap. Orientation ratio assists in setting up a memory of the polymer in the extruded form, for instance as a pipe, which is different than the molten polymer's form in a free state.

In these embodiments, it is preferred that the pipe have a diameter to wall thickness ratio ranging from 5 to 32.

It is also preferred in these embodiments, that the polyamide be a high tensile strength polyamide such as, but not limited to, nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

In some embodiments, at least a portion of the outer surface of a pipe of the present invention is covered by a reinforcing material. Examples of reinforcing materials include, but are not limited to, glass fiber, carbon fiber, nylon fiber, polyester fibers and steel wire and combinations thereof.

Reinforcing materials as described herein can also be sandwiched between two or more layers of the extruded polyamide resin to form a pipe of the present invention.

In some embodiments, the pipe is coated with a colorant such as paint to increase resistance to ultraviolet light and to prevent wear of the pipes. Coating a pipe of the present invention with an acrylic white paint was found to minimize moisture absorption and to significantly reduce temperature increase when exposed to sunlight by 15 to 30° C. as compared to an uncoated pipe.

To improve moisture resistance and minimize abrasion, the outer and inner surface of a thermoplastic pipe may be covered by a second thermoplastic material. The second thermoplastic material may be bonded or unbonded to the thermoplastic pipe. Examples of bonded or unbonded pipes are disclosed in WO 02/061317 and US 2012/0261017 A1. The outer covering is often referred to as an outer sheath while the inner covering is often referred to as an inner sheath.

Accordingly, in some embodiments of the present invention, at least a portion of the outer surface of the pipe and/or the inner surface of the pipe is bonded with a second thermoplastic material. Examples of second thermoplastic materials which can be bonded to at least a portion of the outer and/or inner surface of the pipe include, but are not limited to, high density polyethylene (HDPE), polyamide, polypropylene, polyphenylene sulfide, polyetheretherketone and rubber, and combinations thereof.

In some embodiments, at least a portion of the outer and/or inner surface of the pipe is covered or lined by an unbonded second thermoplastic material. Examples of unbonded second thermoplastic materials which can cover at least a portion of the outer surface of the pipe or line at least a portion of the inner surface of the pipe include, but are not limited to, high density polyethylene (HDPE), polyamide, polypropylene, polyphenylene sulfide, polyetheretherketone and rubber, and combinations thereof.

In some embodiments, the pipes of the present invention may further comprise a silicone based additive. In one embodiment, the pipe comprises 0.5 to 25% by weight of a silicon based additive. In one embodiment, the silicon based additive comprises an ultrahigh molecular weight siloxane polymer and a binding agent. Preferred is that the ultrahigh molecular weight siloxane polymer be unfunctionalized and non-reactive with the polyamide in the pipe. Further preferred is that the unfunctionalized siloxane polymer not be considered as either a gel or an oil. Suitable binding agents for the silicone based additive include, but are not limited to fumed silica. A nonlimiting example of a commercially available formulation is sold under the name Genioplast® Pellet S by Wacker.

An advantage of the pipes of the present invention is that they are capable of being butt fused with another thermoplastic pipe of the same composition and/or coupled with another pipe of the same or different composition through electrofusion, compression fitting and/or transition fitting. In one nonlimiting embodiment, a pipe of the present invention is electrofused, compression fitted or transition fitted to a steel pipe or fitting. In another nonlimiting embodiment, a pipe of the present invention is electrofused, compression fitted, or transition fitted to another thermoplastic pipe of the same composition. In yet another nonlimiting embodiment, a pipe of the present invention is electrofused, compression fitted or transition fitted to another thermoplastic pipe of a different composition.

In one embodiment, the pipe of the present invention further comprises a second polymer, copolymer, or terpolymer made by combining two or more polymers. Examples include, but are not limited to polyamides such as: nylon 6; nylon 4,6; nylon 6,12; nylon 6,10; nylon 6T; nylon 6I; nylon 9T; nylon DT; nylon DI; nylon D6; nylon 7; nylon 11; and nylon 12; polyolefins, polyesters and copolyesters, and combinations thereof. In this embodiment, the second polymer, copolymer or terpolymer can be added prior to extrusion as a melt blend or co-extruded with the resin of the present invention, or added as a separate layer before or after the extrusion of resin of the present invention by, for example, a cross-head, spraying on as a coating, or via a dip coating process.

Also provided in the present invention are processes for extruding thermoplastic polyamide containing pipes. Manufacturing of pipe and other components via extrusion requires the base polymer to have a very high melt strength. High melt strength is essential to obtain a good hang strength, thus enabling production of a uniform shape or form to be extruded and maintained as the polymer crystallizes. Other important parameters when extruding pipes include, but are not limited to, consistent ovality and thickness, smooth inside surface without deformities, ability to coil without crushing upon itself; and no tears or holes on the outside surface. To make pipes with melt strength, the extrusion process may be be started with a high melt strength polymer of the same or another family, and then gradually move over to the desired polymer. The entire process to transition to pure low melt strength polymer preferably takes place within about 10 minutes of start-up to minimize scrap. When using a low melt strength polymer, the gap between the die head/pipehead and the calibrator must be closed down to between 0.5 mm to 75 mm, preferably between 1 mm to 3 mm.

In these processes, a melted polyamide containing thermoplastic resin with a moisture level of the polyamide less than the equilibrium moisture content of the polyamide is extruded and passed through a pipe forming zone of an extrusion apparatus to form the thermoplastic pipe.

Various methods for reducing the moisture level of the polyamide less than the equilibrium moisture content of the polyamide can be used.

In one nonlimiting embodiment, a polyamide containing thermoplastic resin is first dried to a moisture level less than the equilibrium moisture content for the polyamide. Drying of the resin can be achieved by any means including, but not limited to, use of a dessicant bed dryer with appropriate heat, IR heating, forced diffusion using dry air, use of a vented twin screw extruder, microwave heating followed by forced air diffusion, or use of twin screw extruder preferably with atmospheric and vacuum vents, use of a vented single screw extruder, or a combination of the above.

In another embodiment, moisture content is lessened during the extrusion of the melted polyamide containing thermoplastic resin. Nonlimiting examples of apparatus which can be used for extrusion and lessening of the moisture content include, but are not limited to, vented single and twin extruders.

As will be understood by the skilled artisan upon reading this disclosure, alternative methods and apparatus to those exemplified herein which result in a decrease in the moisture level of the composition or resin to less than the equilibrium moisture content for the polyamide are available and use thereof is encompassed by the present invention.

In one embodiment, the polyamide containing thermoplastic resin used in the process comprises 60 to 99.9% by weight of a polyamide and 0.5 to 40% by weight of an impact modifier containing maleic anhydride or a functional equivalent thereof. In this embodiment, it is preferred that the polyamide be a high tensile strength polyamide such as, but not limited to, nylon 6,6; nylon 6; nylon 4,6; nylon 6,12; nylon 6,10; nylon 6T; nylon 6I; nylon 9T; nylon DT; nylon DI; nylon D6; and nylon 7; or a combination thereof. In one embodiment, the polyamide is nylon 6,6 having an initial relative viscosity of 35 to 240 and the moisture level of the polyamide containing thermoplastic resin is decreased before or during the extrusion process to less than 0.15% to 0.005% by weight. Also preferred is that the impact modifier have an effective maleic anhydride level of less than 1% by weight, more preferably 0.044 to 0.11% by weight. In one embodiment, the impact modifier comprises a maleated ethylene propylene diene rubber. The polyamide containing thermoplastic plastic resin may further comprise a heat stabilizer and/or a colorant.

In one embodiment of the present invention the resin further comprises a plasticizer.

In another embodiment, the resin does not further comprise or contain a plasticizer.

The polyamide containing resin is added to an extrusion apparatus and the polyamide containing resin is melted.

Various methods and apparatuses for extruding thermoplastic resins into pipes are known and can be used for production of pipes of the instant invention. For example, in one embodiment, melting may be done in a single screw greater than or equal to 1″ or a 25 mm or greater twin screw extruder to produce a homogeneous melt. The extruders may be with or without a vent. Pipe head temperature is maintained within 20° C. of the melt temperature of polymer. A calibrator with a coolant, preferably water in the temperature range of 16-23° C., is also used. The flow rate of water in the cooling tank is maintained such that outside skin freezes instantaneously upon contact, and the outside pipe temperature is within 50-75° C. of the glass transition temperature of polymer.

In one embodiment, the extrusion apparatus comprises a static mixer and a rotating screw design configured to melt the polyamide containing thermoplastic resin. In alternative embodiments, a single screw extruder, a twin screw extruder, a vented single screw extruder or a vented twin screw extruder is used.

Use of the static mixer in the process of the present invention was found to significantly improve the surface quality of the inside surface of the pipe. When a static mixer was used in the process, the inside surface of the pipe was observed to have a glossy finish. Other advantages of using a static mixer include thermal homogenization, minimize melt memory, uniform viscosity and density, enhanced mixing of colors and minor additives, efficient use of all raw materials, elimination of streaks or clouds in the pipe, consistent quality and higher yield (less rejects).

In one embodiment, the polyamide containing thermoplastic resin is melted at temperature ranging between 260 and 310° C.

The melted polyamide containing thermoplastic resin is then extruded and passed through a pipe forming zone of the extrusion apparatus to form the thermoplastic pipe. Positive pressure may be applied to the internal cavity of the formed pipe through mandrel or pin. In one aspect of this embodiment, the process further comprises the step of passing the portion of a thermoplastic pipe through a dryer.

In one embodiment of this process of the present invention, the residence time from extrusion to pipe forming is less than 20 minutes, more preferably less than 10 minutes, more preferably less than 6 minutes. Examples of pipe forming zones include, but are not limited to, spiral or basket shaped die head, transition zone, a heated mandrel with or without a heated pin which forms at least a portion of a thermoplastic pipe. When using a heated mandrel or pin, positive pressure may be applied to the internal cavity of the formed pipe through mandrel or pin.

In one embodiment, the process of the present invention further comprises passing the melted polyamide containing thermoplastic resin through a screen to remove any contaminants or unmelted portions prior to extrusion. In this embodiment, the screen may be reinforced by a breaker plate to create pressure in the extruding apparatus.

The present invention also provides extruded thermoplastic pipe comprising a polyamide which maintain their ovality. This allows the pipe to be coiled in a spool for storage and transport and to be readily installed from the spools. By maintaining its ovality, the pipes can be used for fluid transfer along long distances. This is useful for application in, for example, oil and gas pipeline, for transporting hydrocarbon containing fluids, water transportation in fracking, water systems for residential and commercial facilities and/or transport of compatible chemicals. The present invention also provides articles of manufacture comprising a coiled pipe of the present invention as well as methods for coiling the pipe.

In one embodiment of the present invention, the thermoplastic pipe of the present invention is coiled onto a coiling apparatus without addition of stresses which would result in a loss in LTHS or tensile strength. The thermoplastic pipe is capable of being clamped by a squeeze-off tool to control the flow of fluid through the pipe and then, upon release of the pipe from the squeeze-off tool, substantially return to its original shape. Additionally, it has been shown that the thermoplastic pipe of the present invention can be subjected to hot oil treatment at up to 150° C. without dimensional distortion.

In this embodiment of the present invention, the pipe is designed to ensure that the coiling strain is less than the yield strain of the polyamide to minimize memory effects and to eliminate or minimize the need for pipe straighteners to tamers. For purposes of the present invention, coiling strain is determined by dividing the outer diameter of the pipe by the inner coil diameter and multiplying by 100. In one embodiment of the present invention the coiling strain from about 1% to about 30%, more preferably from about 3% to about 6%. The diameter and/or length of coiled pipe is selected based upon efficient transportation mode on trucks to meet Department of Transportation regulations and minimize costs. Pipes of the present invention are coiled in lengths typically ranging from about 500 to about 2000 feet based upon the pipe diameter. For example, a 2 inch outer diameter pipe is typically coiled in a length of about 2000 feet, a 3 and 4 inch outer diameter pipe is typically coiled in a length of about 1000 feet, and a 6 inch outer diameter pipe is typically coiled in a length of about 500 feet. Preferred is that the coiled pipes of present invention comprise 60 to 99.9% by weight of a polyamide, wherein the moisture level of the polyamide is less than the equilibrium moisture content of the polyamide, and 0.5 to 40% by weight of an impact modifier containing maleic anhydride or a functional equivalent thereof. Also preferred is that the polyamide be a high tensile strength polyamide such as, but not limited to, nylon 6,6; nylon 6; nylon 4,6; nylon 6,12; nylon 6,10; nylon 6T; nylon 6I; nylon 9T; nylon DT; nylon DI; nylon D6; and nylon 7; or a combination thereof. In one nonlimiting embodiment, the polyamide is nylon 6,6 having an initial relative viscosity of 35 to 240 and the moisture level of less than 0.15% to 0.005% by weight. Also preferred is that the impact modifier has an effective maleic anhydride level of less than 1% by weight, more preferably 0.044 to 0.11% by weight. In one nonlimiting embodiment, the impact modifier comprises a maleated ethylene propylene diene rubber. The thermoplastic resin may further comprise a heat stabilizer and/or colorant as well as additional additives such as, but not limited to, lubricants, mineral fillers, pigments, dyes, antioxidants, hydrolysis stabilizers, nucleating agents, flame retardants, blowing agents and combinations thereof. Suitable mineral fillers include, but are not limited to, kaolin, clay, talc, and wollastonite, diatominte, titanium dioxide, mica, amorphous silica, glass beads, glass fibers and combinations thereof.

Pipes of the present invention have been proven to be effectively coiled and uncoiled in sizes up to 6″. As nonlimiting examples, an inside coiling diameter of 52″ was used for a 2″ outer diameter pipe, an inside coiling diameter of 75″ was used for a 3″ outer diameter pipe, and 90″ inside coiling diameter was used for a 4″ outer diameter pipe. The outer diameter of a 1000 ft coil made with 3″ pipe was about 104 inches, while that for 4″ pipe was about 126 inches.

In some embodiments of the present invention, it may be further desirable to increase the melt viscosity of the resin by addition of 0.1 to 5%, more preferably 1% or less, of an olefin (ethylene, styrene, vinayl acetate)-maleic anhydride copolymer. Preferred is that the olefin and maleic anhydride copolymer having a molecular weight in the range of about 500 to about 400,000 g/mol. Suitable melt viscosity enhancers for use in the present invention include any such that are known in the art. In one nonlimiting embodiment, the olefin is ethylene. A commercially available 1:1 copolymer of ethylene-maleic anhydride is sold under the name ZeMac® by Vertellus®. A commercially available styrene-maleic anhydride copolymer is sold by Cray Valley.

In one embodiment of the present invention resin composition further comprises a plasticizer.

In another embodiment, the resin does not further comprise or contain a plasticizer.

In the coiling process of the present invention, an extruded thermoplastic polyamide pipe is coiled at a ratio of outer pipe diameter to coiling diameter of less than 30% and/or a coiling strain of about 1% to about 30%, more preferably about 3 to about 6%, more preferably less than 5%. Preferred in this process is that the coiling diameter be greater than or equal to 3-30 times the outer diameter of the pipe, preferably 15-25 times the outer diameter of the pipe. The length of pipe to be coiled, and therefore the coil diameter, is selected based upon efficient transportation mode on trucks to meet Department of Transportation regulations and minimize costs. Pipes of the present invention are coiled in lengths typically ranging from about 500 to about 2000 feet based upon the pipe diameter. For example, a 2 inch outer diameter pipe is typically coiled in a length of about 2000 feet, a 3 and 4 inch outer diameter pipe is typically coiled in a length of about 1000 feet, and a 6 inch outer diameter pipe is typically coiled in a length of about 500 feet.

In one embodiment, the coiling force to coil a 3″ SDR11 pipe of the present invention in coils of diameter from 70-90″ has a power requirement from 0.30-1.6 hp, more preferable from 0.08-0.3 hp, and a torque of 687 ft-lb, more preferably from 687-2632 ft-lb torque.

The coiled pipes of the present invention can be uncoiled and installed as straight pipe without any pipe straighteners or pipe tamers and can be bent at angles required for service. In one embodiment, the uncoiling force varies from 440-4543 lb, more preferably from 440-900 lb for safer installation.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

The following section provides further illustration of the compositions, resins, pipes, articles of manufacture and processes of the present invention. Compositions, resins and pipes tested in these nonlimiting examples comprised nylon 6,6 and combinations of nylon 6,6 and nylon 6. Well known by those skilled in the art, however, are other high tensile strength polyamides such as nylon 6; nylon 4,6; nylon 6,12; nylon 6,10; nylon 6T; nylon 6I; nylon 9T; nylon DT; nylon DI; nylon D6; and nylon 7; and/or combinations, which are expected to exhibit similar desired melt strength and viscoelastic behaviors to those described herein for nylon 6,6 and nylon 6,6, and nylon 6 combinations when effective maleation levels and moisture content are balanced in accordance with the teachings herein. Thus, these working examples are illustrative only and are not intended to limit the scope of the invention in any way.

### EXAMPLES

### Example 1

### Compositions/Resins

A first nylon 6,6, resin tested in the following examples comprised 69.1% of a TORZEN™ PA66 U4800 NC01 nylon 6,6 pellet from INVISTA with 48RV, 22% of the impact modifier Exxelor™ VA1840 from ExxonMobil [22%], 0.9% of the heat stabilizer Zytel® FE-7108 Cu from DuPont™, and 2% nigrosine, a mixture of synthetic black dyes.

Resins with RVs of 80 and 240 were prepared as described for 48RV. Solid state polymerization was used to modify the RV to 80 and 240.

A second nylon 6,6 and nylon 6 blend resin tested in the following examples comprised 69.1% of a TORZEN™ PA66 U4800 NC01 nylon 6,6 pellet from INVISTA, 22% of the impact modifier Exxelor™ VA1840 from ExxonMobil [22%], 0.9% of the heat stabilizer Zytel® FE-7108 Cu from DuPont™, and 8% of the colorant 25% Carbon Black (UV-CB) in N6, CNH-00205-A from Polymer Partners.

### Example 2

### Determination of Melt Strength

Melt strength of the compositions of Example 1 were determined utilizing a Goettfert Rheo-Tens instrument. The compositions were melted and the temperature of the molten compositions was kept constant at a desired value within the capillary in accordance with the below listed parameters.

Parameters of Melt Strength Test were as Follows:

Wheel Position approx. 114 mm below the die

Wheel Temperature approx. 23° C.

Barrel Diameter 12 mm

Die entry angle 180°

Die inner diameter 2 mm

Die length 30 mm

Time 6 minutes

Barrel Temp. varied from 270-320° C.

Moisture varied from 0.02% to 0.2%

The compositions were then extruded through a die by application of pressure. The molten extrudate was accelerated on take-away wheels and the resulting load at break in Newtons was measured.

Data is shown in Tables 1 through 4.

### Example 3

### Analysis of Moisture Content

Moisture in the molten compositions of Example 2 was analyzed by the Moisture Analysis Method ASTM D6869-03 (2011), a standard test method for coulometric and volumetric determination of moisture in plastics using the Karl Fischer Reaction, also known as the reaction of iodine with water, using a Metrohm Karl Fischer Coulometer. Data is depicted in Tables 1 through 4.

TABLE 1
Melt Strength and Moisture Content Data for Nylon
6,6 48RV Composition @ 270° C.

| | Velocity at break | Load at break |
|---|---|---|
| Moisture level | (mm/s) | (N) |
| 0.04% | | |
| run 1 | 205.13 | 0.12 |
| run 2 | 227.14 | 0.12 |
| run 3 | 218.59 | 0.12 |
| Mean | 216.95 | 0.12 |
| Std Dev | 11.1 | 0 |
| 0.10% | | |
| run 1 | 185.59 | 0.093 |
| run 2 | 307.35 | 0.072 |
| run 3 | 188.35 | 0.079 |
| Mean | 227 | 0.081 |
| Std Dev | 69.6 | 0.011 |
| 0.15% | | |
| run 1 | 274.95 | 0.055 |
| run 2 | 331.31 | 0.082 |
| run 3 | 287.62 | 0.067 |
| Mean | 298.63 | 0.068 |
| Std Dev | 30.7 | 0.014 |

TABLE 2
Melt Strength and Moisture Content Data for Nylon
6,6 80RV Composition @ 270° C.

| Moisture level | Velocity at break | Load at break |
|---|---|---|
| 0.10% | (mm/s) | (N) |
| run 1 | 195.70 | 0.08 |
| run 2 | 221.45 | 0.11 |
| run 3 | 273.55 | 0.10 |
| Mean | 230.23 | 0.10 |
| Std Dev | 69.66 | 0.01 |

TABLE 3
Melt Strength and Moisture Content Data for Nylon
6,6 240RV Composition @ 270° C.

| Moisture level | Velocity at break | Load at break |
|---|---|---|
| 0.11% | (mm/s) | (N) |
| run 1 | 234.08 | 0.18 |
| run 2 | 210.43 | 0.19 |
| run 3 | 209.00 | 0.19 |
| Mean | 217.83 | 0.18 |
| Std Dev | 14.08 | 0.01 |

TABLE 4
Melt Strength and Moisture Content Data for Nylon 6,6 48RV
Nylon 6 Blend Composition @ 270° C.

| Moisture level | Velocity at break | Load at break |
|---|---|---|
| 0.10% | (mm/s) | (N) |
| run 1 | 629.40 | 0.09 |
| run 2 | 614.57 | 0.10 |
| run 3 | 445.65 | 0.10 |
| Mean | 563.21 | 0.10 |
| Std Dev | 102.08 | 0.01 |

Tables 1-4 show the effect of moisture content on melt strength. As the moisture content of the composition was decreased further away from the equilibrium moisture content, the melt strength increased.

### Example 4

### Effect of Effective Maleation Level on Melt Strength

Experiments were also performed to determine the effects of varying the amount of impact modifier in the first resin of Example 1, thus altering the effective maleation level in the composition, on melt strength. For these experiments, moisture content of the resin was maintained at 0.04%. Melt strength was assessed as described in Example 2. Results are depicted in Table 5.

TABLE 5

| Effective Maleation Level | Melt Strength |
|---|---|
| % | N |
| 0 | 0.0 |
| 0.049 | 0.05 |
| 0.056 | 0.069 |
| 0.063 | 0.104 |
| 0.07 | 0.15 |
| 0.077 | 0.15 |
| 0.084 | 0.15 |

### Example 5

### Pipe Preparation

A pipe was extruded from melted Nylon 6,6 48RV composition of Example 1 using a single screw or vented/unvented twin screw extruder. The molten polymer was passed through a screen into a heated spiral or basket type die head where the polymer came into contact with a mandrel. The melted polymer then flowed into the gap between the pin of the mandrel and the sleeve, referred to as the die-gap, where the polymer cooled down. Thickness of the pipe was controlled by the die-gap, swell ratio and orientation ratio. Typical extrusion conditions were as follows:

Screw RPM 40-200

Grooved bush temp 40-200° F.

Barrel Temps. (5 barrels) 505-580° F.

Die Temp. (5 dieheads) 500-550° F.

Once the composition passed through the die-gap, it was then passed through a calibrator ring, which was used to size the pipe to the correct outer diameter. Water may or may not be used in the calibrator ring as a lubricant to minimize sticking. The calibrator ring also has the ability to pull a vacuum for correctly sizing the outer diameter of the pipe. The pipe was then moved through two or more cooling tanks with either water spray of atomized droplets or a water bath to cool the pipe to less than 150° C. The extruded pipe used in most experiments herein had standard dimension ratio of 11 with a 3 inch diameter, and produced in a continuous fashion to either make continuous coils or cut into straight section of desired length using a saw. However, the same or similar conditions can be utilized to manufacture bigger or smaller pipe sizes with standard dimension ratios varying from 2 to 32, preferably between 7 to 25.

### Example 6

### Tensile Strength and Burst Pressure Testing of Pipe

Tensile strength and burst pressure tests were performed on the pipe of Example 5.

Three different protocols, specifically quick burst pressure testing without water saturation, quick burst pressure testing after 100% saturation with water, and long term hydrostatic burst pressure testing after 100% saturation with water, were used to assess pipe performance.

Results are shown in Tables 6, 7 and 8, respectively.

Quick burst pressure provides an indication of the short term performance of the pipe. Burst pressures are indicative of the hoop stress and tensile strength of a product. For example, for a 3″ SDR 11 pipe with a minimum wall thickness of 0.318″, a burst pressure of 1400 psi is equivalent to a burst stress of 7700 psi or 53 mPA. If the burst stress calculated from the quick burst pressure is equal to or greater than the tensile strength of the polyamide product, it is indicative of good processing.

For saturation, pipes were submerged in 80° C. water for a period of time until the weight increase was negligible. Typical saturation levels of pipes tested was between 5.4 and 6.2% by weight and took between 18 to 26 days. Average outside diameter (OD) of the pipe specimens increased by approximately 2% upon conditioning in 80° C. water vapor until saturated to a level of approximately 6% by weight.

Pipes were capped with free end type end closures, pressurized to insure no leaks and tested in general accordance with ASTM D1599-99 (2011) Procedure A. In this procedure, pressure was ramped at about 14 to 30 psi/second until failure occurred. Typical failure observed was either a ductile break or a brittle or slit failure mode.

Results for conditioned pipes are depicted in Table 6 while results for unconditioned pipes are depicted in Table 7.

TABLE 6
Quick Burst Test Results (conditioned pipe)

| | Burst Pressure | | |
|---|---|---|---|
| Sample | (conditioned pipe) | Burst Stress | Failure Mode |
| 1 | 801 | 4157 | Ductile |
| 2 | 797 | 4183 | Ductile |
| 3 | 796 | 4198 | Ductile |
| Average* | 798 +/− 2* | 4179 +/− 17* | |

*Results are provided as mean +/− 1 standard deviation

TABLE 7
Quick Burst Test Results (unconditioned pipe)

| | | Min Wall | Outside | Quick Burst | Burst |
|---|---|---|---|---|---|
| Sample | | thickness | D | Pressure | stress |
| Time | Size/SDR | (in) | (in) | (psi) | (psi) |
| 1 | 3 DR 11 | 0.33 | 3.513 | 1305 | 6946 |
| 2 | 3 DR 11 | 0.33 | 3.513 | 1565 | 8330 |
| 3 | 3 DR 11 | 0.33 | 3.513 | 1614 | 8591 |
| 4 | 3 DR 11 | 0.323 | 3.512 | 1601 | 8704 |
| 5 | 3 DR 11 | 0.312 | 3.515 | 1422 | 8010 |
| 6 | 3 DR 11 | 0.31 | 3.515 | 1455 | 8249 |
| 7 | 3 DR 11 | 0.308 | 3.515 | 1500 | 8559 |
| 8 | 3 DR 11 | 0.296 | 3.507 | 1464 | 8673 |
| 9 | 3 DR 11 | 0.294 | 3.506 | 1415 | 8437 |
| 10 | 3 DR 11 | 0.307 | 3.506 | 1438 | 8211 |
| 11 | 3 DR 11 | 0.301 | 3.508 | 1381 | 8047 |
| 12 | 3 DR 11 | 0.286 | 3.505 | 1438 | 8812 |
| 13 | 3 DR 11 | 0.298 | 3.508 | 1396 | 8217 |
| 14 | 3 DR 11 | 0.285 | 3.504 | 1437 | 8834 |
| 15 | 3 DR 11 | 0.262 | 3.5 | 1470 | 9819 |
| 16 | 3 DR 11 | 0.277 | 3.506 | 1395 | 8828 |
| 17 | 3 DR 11 | 0.281 | 3.503 | 1390 | 8664 |
| 18 | 3 DR 11 | 0.274 | 3.502 | 1396 | 8921 |
| 19 | 3 DR 11 | 0.288 | 3.501 | 1410 | 8570 |
| 20 | 3 DR 11 | 0.329 | 3.508 | 1495 | 7970 |
| 21 | 3 DR 11 | 0.326 | 3.506 | 1505 | 8093 |
| 22 | 3 DR 11 | 0.332 | 3.507 | 1519 | 8023 |
| 23 | 3 DR 11 | 0.316 | 3.494 | 1538 | 8503 |
| 24 | 3 DR 11 | 0.341 | 3.491 | 1531 | 7837 |
| 25 | 3 DR 11 | 0.318 | 3.491 | 1475 | 8096 |
| 26 | 3 DR 11 | 0.319 | 3.487 | 1619 | 8849 |
| 27 | 3 DR 11 | 0.313 | 3.487 | 1610 | 8968 |
| 28 | 3 DR 11 | 0.337 | 3.488 | 1582 | 8187 |
| 29 | 3 DR 11 | 0.346 | 3.485 | 1560 | 7856 |
| 30 | 3 DR 11 | 0.324 | 3.491 | 1586 | 8544 |
| 31 | 3 DR 11 | 0.317 | 3.492 | 1605 | 8840 |
| 32 | 3 DR 11 | 0.331 | 3.495 | 1523 | 8041 |
| 33 | 3 DR 11 | 0.318 | 3.496 | 1549 | 8515 |
| 34 | 3 DR 11 | 0.324 | 3.497 | 1599 | 8629 |
| 35 | 3 DR 11 | 0.311 | 3.495 | 1573 | 8839 |
| 36 | 3 DR 11 | 0.315 | 3.504 | 1501 | 8348 |
| 37 | 3 DR 11 | 0.315 | 3.504 | 1550 | 8621 |
| 38 | 3 DR 11 | 0.33 | 3.504 | 1530 | 8123 |
| 39 | 3 DR 11 | 0.335 | 3.508 | 1555 | 8142 |
| 40 | 3 DR 11 | 0.322 | 3.504 | 1495 | 8134 |
| 41 | 3 DR 11 | 0.298 | 3.513 | 1332 | 7851 |
| 42 | 3 DR 11 | 0.299 | 3.512 | 1384 | 8128 |
| 43 | 3 DR 11 | 0.305 | 3.513 | 1415 | 8149 |
| 44 | 3 DR 11 | 0.293 | 3.511 | 1403 | 8406 |
| 45 | 3 DR 11 | 0.297 | 3.509 | 1372 | 8105 |
| 46 | 3 DR 11 | 0.297 | 3.511 | 1410 | 8334 |
| 47 | 3 DR 11 | 0.325 | 3.507 | 1506 | 8125 |
| 48 | 3 DR 11 | 0.332 | 3.501 | 1528 | 8057 |
| 49 | 3 DR 11 | 0.32 | 3.501 | 1491 | 8156 |
| 50 | 3 DR 11 | 0.286 | 3.506 | 1491 | 9139 |
| 51 | 3 DR 11 | 0.287 | 3.505 | 1431 | 8738 |
| 52 | 3 DR 11 | 0.286 | 3.506 | 1432 | 8777 |
| 53 | 3 DR 11 | 0.295 | 3.506 | 1435 | 8527 |
| 54 | 3 DR 11 | 0.288 | 3.506 | 1418 | 8631 |
| 55 | 3 DR 11 | 0.292 | 3.506 | 1434 | 8609 |
| 56 | 3 DR 11 | 0.288 | 3.505 | 1473 | 8963 |
| 57 | 3 DR 11 | 0.287 | 3.505 | 1428 | 8720 |
| 58 | 3 DR 11 | 0.298 | 3.505 | 1474 | 8668 |

After 58 runs, the average quick burst pressure for the unconditioned pipe was 1480 psi, and an average burst stress of 8425 psi, which is about 24% greater than the tensile strength of the polymer.

Long term hydrostatic strength (LTHS) testing was performed on the pipe at 23° C. in accordance with ASTM D2837-11, using the method described in ASTM D1598-02 (2009). Definitions of experimental grade levels (E-Levels) are per PPI TR-3 (2010). The LTHS number indicates the pressure at which the pipe is expected to perform without failure for up to 100,000 hours. The values are computed based upon hydrostatic burst pressure of pipes under 100% saturation conditions at various temperatures of interest. LTHS results shown in Table 8 are for the pipe at 23° C.

TABLE 8
Summary of LTHS Test Results

| | | | 95% | 95% | | | 95% | 95% | |
|---|---|---|---|---|---|---|---|---|---|
| Test | Test | LTHSₚ | LCL | UCL | PDB | LTHS | LCL | UCL | HDB |
| Description | Hours | (psig) | (psig) | (psig) | (psig) | (psi) | (psi) | (psi) | (psi) |
| E-2 at 23° C. | 1144 | 458 | 436 | 480 | 400 | 2291 | 2181 | 2402 | 2000 |

LTHSₚ: Long Term Hydrostatic Pressure Strength
LTHS: Long Term Hydrostatic Strength
PDB: pressure Design Basis
HDB: Hydrostatic Design Basis
LCL: Lower Confidence Limit
UCL: Upper Confidence Limit

### Example 7

### Assessing Hoop Stress

Hoop stress of the pipe was also determined experimentally at various time intervals using a modified Barlow's equation which relates the internal pressure that a pipe can withstand based on its diameter and wall thickness with the strength of the material. The modified Barlow's equation is as follows:

$$σ ( Burst stress ) = \frac{( Burst Pressure * Outside Diameter of pipe )}{( 2 * minimum wall thickness of pipe )}$$

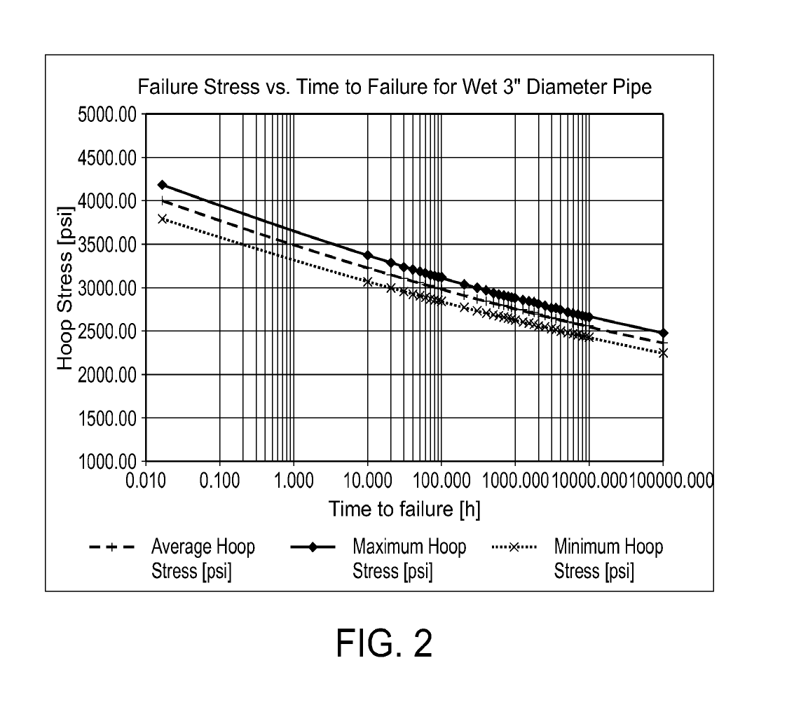

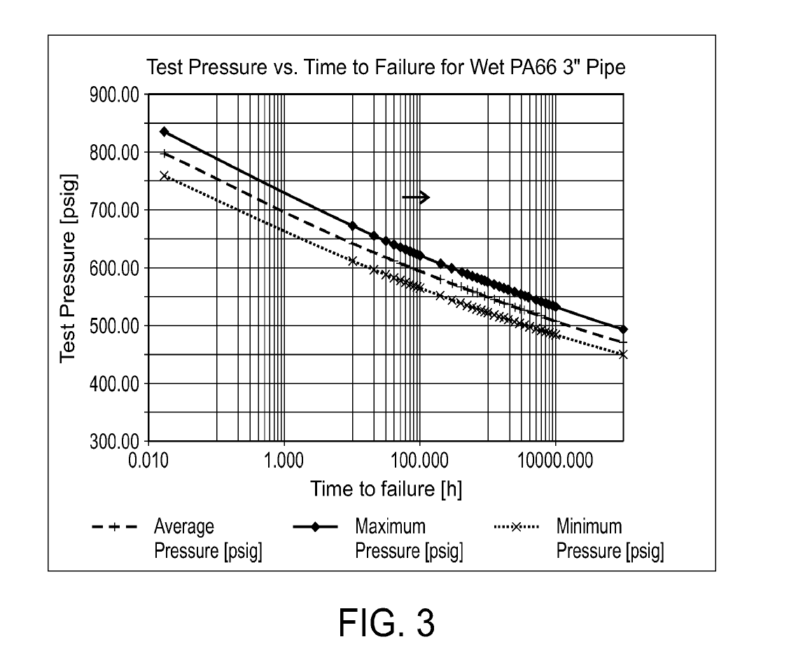

Results are shown in FIG. 2. The average hoop stress value was extrapolated based on 2000 hours of testing to determine the hoop stress after 100,000 hours. Thus, for example, for a pipe of the present invention, the average hoop stress at 100,000 hours was 2291 psi. Based upon the experimental noise around this average data, 95% CI indicates a lower confidence value of 2181 psi and an upper confidence level of 2402 psi. Hoop stress is equal to the pressure time pipe diameter divided by (2*pipe wall thickness of the pipe). Thus, based upon the assessed hoop stress of the pipe, it was calculated that a pipe of the present invention would withstand a constant pressure range of 436 to 480 psi up to 100,000 hours without failure. Results are shown in FIG. 3.

### Example 8

### Butt Fusion

Butt fusion is the process of joining pipe sections using a combination of temperature, pressure, and time. This technique has a significant value in the industry as it is a more cost effective way of joining coiled and straight sections of pipe as compared to other techniques such as electrofusion or mechanical fittings. It is important that the fusion joints have properties equal to or greater than the pipe material itself, referred to herein as parent material such that these sections are not the weakest links in piping systems. Nylon 6,6 has traditionally posed a challenge as this polymer has a high tendency to rapidly crystallize.

A series of butt fusions were prepared using various combinations of pipe, heater plate temperatures and heating times. For these tests, pipes were prepared from a composition of Example 1 with 2″ to 6″ outer diameters. Butt fusions were performed at in a controlled environment of 73° F. and 50% relative humidity. A heater for fusion with a minimum power capacity to handle the above pipe sizes was allowed to heat to a surface temperature of 536° F. Butt fusion ends of the pipes to be joined were cleaned by a rotating knife. The heater was then applied to both surfaces and the pipe ends were heated until a nice bead (about 0.1″ width) formed on each side of pipe. The ends were then joined at a contact pressure of about 75 psi. The contact pressure was then reduced to 35 psi and held for a specified time (120 sec for 3″ DR 11 pipe) while the heat soaked deep into the pipe. The heater was then removed and the contact pressure of 75 psi was again quickly applied and continued while the butt fusion cooled down to a warm to touch temperature, about 120° F. For a 3″ SDR 11 pipe of the present invention, this process took 16 minutes. The contact pressure was then reduced to zero and the pipe joint was held in the fixture for another 15 minutes, so the weld joint material could stabilize.

More specific details of the butt fusion process are depicted in the following Table 9.

TABLE 9

| Parameters | | Values, British | | Values, ISO | |
|---|---|---|---|---|---|
| Area | | 0.785* (OD² − ID²) | | | |
| Heater Plate Temperature | | 536 | F. | 280 | C. |
| Phase 1 | Pressure, p₁ | 75 | psi | 0.52 | MPa |
| | (Contact | | | | |
| | Pressure) | | | | |
| | Time, t₁: bead | ~1.0 | minute | 2 | minute |
| | formation → | | | | |
| | Bead Width, | 0.1″ | | 2.5 | mm |
| | B₁ | | | | |
| Phase 2 | Pressure, p₂ | 35 | psi | 0.24 | MPa |
| | Time, t₂: Heat | 2 | minutes | 2 | minutes |
| | Soak | | | | |
| Phase 3 | Time, t₃: Open/ | less than 5 seconds | | less than 5 sec. | |
| | Close Time | | | | |
| Phase 4 | Time, t₄: Butt | 7 | seconds | 7 | seconds |
| | Fusion Startup | | | | |
| Phase 5 | Pressure, p₃ | 75 psi +/− 15 psi | | 0.52 +/− 0.1 MPa | |
| | Time, t₅ | 15 | minutes | 15 | minutes |

| | | | |
|---|---|---|---|
| Phase 6 | Time, t₆: | Release when bead | Release when bead |
| | Cooling Time | reaches warm to | reaches warm to |
| | | touch temperature | touch temperature |

*All pressure values are based on contact pressure (applied force)/(pipe section area), not the hydraulic pressure gage reading of pressure cylinder.

Results are depicted in the following Tables 10 and 11.

TABLE 10

| | Heaterplate | Heating | |
|---|---|---|---|
| Pipe | Temperature | time | |
| Configuration | Range | (sec.) | Notes |
| ambient-ambient | 496-501° F. | 135 | First attempt to fuse, |
| | | | temperature too low for |
| | | | fusion. |
| ambient-ambient | 524-529° F. | 165 | Failed bendback test |
| ambient-ambient | 524-531° F. | 135 | This joint was used in |
| | | | tensile testing. |

Based on the design of the experiment, optimum welding conditions for Nylon 6,6 material were obtained.

TABLE 11

| | Yield | | Tensile | |
|---|---|---|---|---|
| | Strength/ | % Elongation | Strength/ | % Elongation |
| | Std. Dev., | @ Yield/ | Std. Dev., | @ Break/ |
| Configuration | 5 psi | Std. Dev. | psi | Std. Dev. |
| Ambient Pipe | 7221/138 | 23/7 | 7225/138 | 59/5 |
| Fusion: | 7177/179 | 13/5 | 7206/167 | 27/17 |
| Ambient to | | | | |
| Ambient | | | | |

Butt Fusion joint strength of the Nylon 6,6 pipe was equal to the parent pipe material strength.

### Example 9

### Rapid Crack Propagation (RCP) Data for Pipe

A 4″ SDR11 made from the first nylon 6,6 resin of Example 1 was used for rapid crack propagation study.

Historically, resistance of the pipe to rapid crack propagation (RCP) was first determined using a small-scale steady-state test (S4 test): ISO 13477. Rapid decompression ahead of the propagating crack is retarded by internal baffles and by an external cage that restricts flaring of the test pipe at the edges of the fracture. Hence this technique achieves steady-state rapid crack propagation (RCP) in a short pipe specimen at a lower pressure than that necessary to achieve propagation in the same pipe using a full-scale test.

Resistance of the pipe to RCP was also determined using a full-scale test (FST): ISO 13478. The test simulates the performance of a buried pipe in service under conditions which do not retard the rate of decompression of the pressurizing fluid through any fracture.

For fast crack initiation, an impact was made near one end of the sample which is designed to initiate a fast-running longitudinal crack. Using a metal striker blade (25° wedge), this impact was applied to the outer surface of the test pipe, which was transferred to the pipe hoop to initiate the crack. This means that impact was applied to the outer diameter of the pipe, which resulted in energy transfer across the entire circumference of the pipe, also referred to as pipe hoop stress. The impact was applied through a narrow longitudinal slit with a sharp notch machined at the end of the pipe. The artificially initiated crack process is designed so that it disturbs the test pipe as little as possible.

For assessing rapid crack propagation, the following parameters are important:

Crack propagation driving force which is the strain energy stored in the pipe wall;

Critical pressure p_{c} which is the pressure at which a sharp transition from abrupt arrest of an initial crack to continuous steady propagation of the crack occurs.

At any pressure greater than the critical pressure P_{c}, the crack can propagate indefinitely. Below the critical pressure p_{c}, however, even a running crack will be promptly arrested. The critical pressure is determined by pipe dimensions, material, temperature, and the pressurizing medium;

As temperatures decreases, the propensity of crack propagation increases. For every temperature, there is a certain critical pressure (Pc) above which if crack is initiated, it will propagate. Conversely, for every operating pressure, there is a critical temperature (Tc) below which if crack is initiated, it will propagate. The Pc can converted into its corresponding burst stress (Sc) using Barlow's equation, such that it can be normalized for use in different pipe dimensions. In rapid crack propagation or arrest, if the crack propagation rate exceeds the decompression wave speed, the crack will propagate. Conversely, if the decompression wave speed exceeds the crack propagation rate, the strain energy within the pipe wall is quickly released; lacking a driving force, the crack is subsequently arrested.

Testing performed on a pipe of the present invention used a controlled internal pressure (CIP) test that establishes the critical pressure p_{c} temperature dependency similarly to the standard tests. In addition to the critical pressure p_{c}, the CIP test allows a quantitative characterization of material ability to arrest rapid crack expressed in terms of the energy release rate (ERR) at crack arrest G₁^{AR} (dynamic toughness). Using the CIP test, the arrest or dynamic propagation of a crack initiated by a dynamic impact on a thermoplastics pipe at a specified temperature and internal pressure can be determined. As with the full-scale (FST) and S4 tests, a dynamic impact near one end of the sample was designed to initiate a fast-running longitudinal crack. For rapid crack propagation, a thin rubber liner was inserted inside the pipe to prevent depressurization (escape of the pressurizing fluid or gas) through the crack opening. The rapid crack propagation trajectory and the crack speed were recorded. RCP data for the pipe and critical temperature are set forth below in Tables 12 and 13, respectively.

TABLE 12
RCP Data for Pipe

| Temperature | −20° C. | | −12° C. | | −2° C. | | 10° C. | 21° C. |
|---|---|---|---|---|---|---|---|---|
| Critical Pressure (p_{c}) psi-CIP | 50 | | 60 | | 80 | | 150 | >200 psi |
| method | | | | | | | | |
| Crack Length @ Arrest - CIP | 230-390 | mm | 270-450 | mm | 285-450 | mm | | NA |
| method | | | | | | | | |
| Dynamic Toughness | 4.2 | KJ/m² | 9.8 | KJ/m² | 14.6 | KJ/m² | | NA |
| G₁^{AR} (ERR @ Arrest) | | | | | | | | |

| | | | | | |
|---|---|---|---|---|---|
| Critical stress (Sc) - CIP | 275 | 330 | 440 | 825 | >1100 |
| method; psi | | | | | |
| Critical stress (Sc) - | 2751 | 3301 | 4401 | 8252 | >11002 |
| expected FST Upper limit | | | | | |
| Critical stress (Sc) - | 1375 | 1650 | 2200 | 4126 | >5500 |
| expected FST lower limit | | | | | |
| (psi) | | | | | |

TABLE 13
Critical Temperature T_{c}

| Pressure | 150 psi | 80 psi | 60 psi | 50 psi |
|---|---|---|---|---|
| T_{c} | 18-10° C. | −2° C. | −12° C. | −20° C. |

The critical pressure values in Table 12 can be multiplied by a factor of 10 to calculate the upper range of Critical Pressures (p_{c}) for full-scale pipe based on experiments, while critical pressure values in Table 12 can be multiplied by a factor of 5 to calculate the lower operating pressure range. Thus, for a 4″ SDR11 pipe of the present invention, it is estimated that the critical pressure is between 250-500 psi at −20° C. This enables operators of these pipes to ensure that correct pipe dimensions may be specified to meet the maximum operating pressure (MOP) conditions expected to be seen. Similarly, at −2° C., this is estimated to be between 400-800 psi, while it is estimated to be between 750-1500 psi at 10° C., and >1200 psi at 21° C. If Pc are above MOP for a particular pipe dimension (outer diameter and SDR ratio), then there is sufficient safety factor accounted during operations to minimize the risk of crack propagation in the event of crack initiation.

### Example 10

### Viscosity & Die Swell Data

Polymer rheology was measured to characterize the complex flow behavior of melted nylon 6,6, resin compositions of Example 1. A capillary rheometer measured viscosity as a function of temperature and shear rate. A Goettfert rheometer was utilized to directly measurement melt pressures through a side mounted pressure transducer. Properties of polymeric materials were measured by Method: ASTM D 3835: 2008, by means of a Goettfert Rheograph 2003 Capillary Rheometer. Data for a composition with an initial relative viscosity of 48 is depicted in Table 14 while data for a composition with an initial relative viscosity of 80 is depicted in Table 15.

TABLE 14
Viscosity & Die Swell Data: 48RV @ 270° C.

| Shear rate s⁻¹ | Viscosity Pa · s | Die Swell Ratio |
|---|---|---|
| 10 | 2193.4 | 1.6 |
| 20 | 1249.0 | 1.3 |
| 50 | 818.3 | 1.8 |
| 100 | 610.7 | 1.5 |
| 200 | 491.6 | 2.1 |
| 500 | 335.9 | 2.1 |
| 1000 | 246.7 | 1.9 |
| 2000 | 173.7 | 1.6 |
| 5000 | 105.3 | 2.1 |
| 10000 | 70.6 | 2.4 |

TABLE 15
Viscosity & Die Swell Data: 80RV @ 270° C.

| Shear rate s⁻¹ | Viscosity Pa · s | Die Swell Ratio |
|---|---|---|
| 10 | 2741.8 | 1.1 |
| 20 | 1706.0 | 1.4 |
| 50 | 1123.7 | 1.6 |
| 100 | 812.2 | 1.8 |
| 200 | 586.3 | 1.9 |
| 500 | 376.2 | 2.2 |
| 1000 | 265.6 | 2.4 |
| 2000 | 190.5 | 2.6 |
| 5000 | 118.0 | 2.6 |
| 14608 | 54.0 | 3.0 |

Determination of the swell behavior allows for proper design of the melting process to enable acceptable shear rate, and also design the orientation ratio of die to shape the melt in the form of article desired by removing free state memory to produce excellent surface quality.

### Example 11

### Determination of Thermal Stability by Cone and Plate Rheology

Typical thermoplastic polymers, especially polyamides such as those described in Example 1 have an elastic and viscous region in both the solid and the melt phase. The special characteristics of melt phase behavior of these compositions enables production of good extruded articles. These characteristics include the high melt strength on one hand, while being shear sensitive on the other to provide for tailoring the shear rate with process equipment for various articles of interest. The characteristic of elastic region relates to the point at which the melt recovers its original dimension when subjected to a stress (or force applied over a cross-sectional area), while viscous region is the point at which the material becomes permanently deformed when subjected to a certain stress.

To characterize these behaviors, a parallel plate viscometer was used to determine storage modulus (G′) and loss modulus (G″) in the melt phase. Tables 16, 17 and 18 show the effect of shear rate on G′ and G″ values at 270, 280 and 290° C., respectively. Regions where G′ is greater than G″ is indicative of highly elastic behavior, while regions where G″ is greater than G′ is indicative of less elastic and more viscous behavior.

As temperature is increased, the shear rate at which this transition occurs moves to a higher shear regime. For instance, G″ approaches G′ at 10 rad/sec shear rate at 270° C., while it is 400 rad/sec at 280° C., and it remains more elastic than plastic at 290° C. up to 1000rad/sec.

TABLE 16
DMA Data

| Temp | ω | η* | G′ | G″ |
|---|---|---|---|---|
| ° C. | rad/s | Pa*s | Pa | Pa |
| 270 | 1.00E−01 | 2.34E+04 | 2.16E+03 | 8.95E+02 |
| 270 | 1.47E−01 | 1.81E+04 | 2.48E+03 | 9.68E+02 |
| 270 | 2.15E−01 | 1.41E+04 | 2.81E+03 | 1.14E+03 |
| 270 | 3.16E−01 | 1.07E+04 | 3.12E+03 | 1.32E+03 |
| 270 | 4.64E−01 | 8.20E+03 | 3.45E+03 | 1.61E+03 |
| 270 | 6.81E−01 | 6.27E+03 | 3.84E+03 | 1.88E+03 |
| 270 | 1.00E+00 | 4.78E+03 | 4.17E+03 | 2.35E+03 |
| 270 | 1.47E+00 | 3.75E+03 | 4.65E+03 | 2.95E+03 |
| 270 | 2.15E+00 | 2.95E+03 | 5.19E+03 | 3.67E+03 |
| 270 | 3.16E+00 | 2.35E+03 | 5.83E+03 | 4.63E+03 |
| 270 | 4.64E+00 | 1.92E+03 | 6.67E+03 | 5.89E+03 |
| 270 | 6.81E+00 | 1.59E+03 | 7.76E+03 | 7.51E+03 |
| 270 | 1.00E+01 | 1.33E+03 | 9.16E+03 | 9.60E+03 |
| 270 | 1.47E+01 | 1.12E+03 | 1.10E+04 | 1.22E+04 |
| 270 | 2.15E+01 | 9.50E+02 | 1.33E+04 | 1.55E+04 |
| 270 | 3.16E+01 | 8.09E+02 | 1.64E+04 | 1.96E+04 |
| 270 | 4.64E+01 | 6.89E+02 | 2.04E+04 | 2.47E+04 |
| 270 | 6.81E+01 | 5.87E+02 | 2.54E+04 | 3.09E+04 |
| 270 | 1.00E+02 | 4.99E+02 | 3.19E+04 | 3.83E+04 |
| 270 | 1.47E+02 | 4.23E+02 | 4.01E+04 | 4.73E+04 |
| 270 | 2.15E+02 | 3.57E+02 | 5.05E+04 | 5.79E+04 |
| 270 | 3.16E+02 | 2.99E+02 | 6.32E+04 | 7.02E+04 |
| 270 | 4.64E+02 | 2.47E+02 | 7.85E+04 | 8.37E+04 |

TABLE 17
DMA Data

| Temp | ω | η* | G′ | G″ |
|---|---|---|---|---|
| ° C. | rad/s | Pa * s | Pa | Pa |
| 280 | 1.00E−01 | 4.26E+04 | 4.04E+03 | 1.34E+03 |
| 280 | 1.47E−01 | 3.50E+04 | 4.96E+03 | 1.35E+03 |
| 280 | 2.15E−01 | 2.83E+04 | 5.89E+03 | 1.55E+03 |
| 280 | 3.16E−01 | 2.12E+04 | 6.51E+03 | 1.59E+03 |
| 280 | 4.64E−01 | 1.64E+04 | 7.40E+03 | 1.78E+03 |
| 280 | 6.81E−01 | 1.21E+04 | 8.02E+03 | 2.01E+03 |
| 280 | 1.00E+00 | 8.81E+03 | 8.51E+03 | 2.26E+03 |
| 280 | 1.47E+00 | 6.49E+03 | 9.13E+03 | 2.71E+03 |
| 280 | 2.15E+00 | 4.79E+03 | 9.78E+03 | 3.25E+03 |
| 280 | 3.16E+00 | 3.56E+03 | 1.05E+04 | 4.01E+03 |
| 280 | 4.64E+00 | 2.68E+03 | 1.14E+04 | 4.99E+03 |
| 280 | 6.81E+00 | 2.04E+03 | 1.24E+04 | 6.20E+03 |
| 280 | 1.00E+01 | 1.58E+03 | 1.37E+04 | 7.82E+03 |
| 280 | 1.47E+01 | 1.24E+03 | 1.53E+04 | 9.89E+03 |
| 280 | 2.15E+01 | 9.90E+02 | 1.73E+04 | 1.24E+04 |
| 280 | 3.16E+01 | 8.01E+02 | 1.99E+04 | 1.56E+04 |
| 280 | 4.64E+01 | 6.53E+02 | 2.32E+04 | 1.96E+04 |
| 280 | 6.81E+01 | 5.37E+02 | 2.73E+04 | 2.44E+04 |
| 280 | 1.00E+02 | 4.44E+02 | 3.25E+04 | 3.02E+04 |
| 280 | 1.47E+02 | 3.68E+02 | 3.91E+04 | 3.72E+04 |
| 280 | 2.15E+02 | 3.05E+02 | 4.73E+04 | 4.56E+04 |
| 280 | 3.16E+02 | 2.52E+02 | 5.74E+04 | 5.53E+04 |
| 280 | 4.64E+02 | 2.07E+02 | 6.96E+04 | 6.60E+04 |

TABLE 18
DMA Data

| Temp | ω | η* | G′ | G″ |
|---|---|---|---|---|
| ° C. | rad/s | Pa * s | Pa | Pa |
| 290 | 1.00E−01 | 1.94E+05 | 1.79E+04 | 7.65E+03 |
| 290 | 1.47E−01 | 1.36E+05 | 1.88E+04 | 6.52E+03 |
| 290 | 2.15E−01 | 7.57E+04 | 1.58E+04 | 4.00E+03 |
| 290 | 3.16E−01 | 6.25E+04 | 1.93E+04 | 4.31E+03 |
| 290 | 4.64E−01 | 4.72E+04 | 2.12E+04 | 5.62E+03 |
| 290 | 6.81E−01 | 3.67E+04 | 2.44E+04 | 5.23E+03 |
| 290 | 1.00E+00 | 2.74E+04 | 2.68E+04 | 5.91E+03 |
| 290 | 1.47E+00 | 1.99E+04 | 2.86E+04 | 6.10E+03 |
| 290 | 2.15E+00 | 1.44E+04 | 3.03E+04 | 6.68E+03 |
| 290 | 3.16E+00 | 1.05E+04 | 3.24E+04 | 7.22E+03 |
| 290 | 4.64E+00 | 7.66E+03 | 3.45E+04 | 8.55E+03 |
| 290 | 6.81E+00 | 5.62E+03 | 3.70E+04 | 9.90E+03 |
| 290 | 1.00E+01 | 4.13E+03 | 3.96E+04 | 1.16E+04 |
| 290 | 1.47E+01 | 3.06E+03 | 4.27E+04 | 1.37E+04 |
| 290 | 2.15E+01 | 2.27E+03 | 4.62E+04 | 1.63E+04 |
| 290 | 3.16E+01 | 1.71E+03 | 5.03E+04 | 1.94E+04 |
| 290 | 4.64E+01 | 1.29E+03 | 5.50E+04 | 2.33E+04 |
| 290 | 6.81E+01 | 9.78E+02 | 6.05E+04 | 2.79E+04 |
| 290 | 1.00E+02 | 7.50E+02 | 6.71E+04 | 3.35E+04 |
| 290 | 1.47E+02 | 5.80E+02 | 7.50E+04 | 4.01E+04 |
| 290 | 2.15E+02 | 4.51E+02 | 8.44E+04 | 4.79E+04 |
| 290 | 3.16E+02 | 3.51E+02 | 9.53E+04 | 5.71E+04 |
| 290 | 4.64E+02 | 2.73E+02 | 1.07E+05 | 6.73E+04 |

While not being limited to any specific theory or mechanism of action, it is believed that this unique behavior is due to crosslinking of polymer melt, which to the best of our knowledge is a previously unexplained phenomenon in the art of polymer melts.

Based upon the article of interest to be produced, and the type of operations needed to be performed on the melt, appropriate shear rate and temperature can then be selected.

Further proof of the crosslinking phenomena can be seen when performing thermal stability study by rheological measurement of the polyamide melt using dynamic mechanical procedures using the method ASTM D 4440, 2008 and a Rheometrics ARES as the instrument. Data for compositions with an initial relative viscosity of 48, 80 and 240 are depicted in Tables 19, 20 and 21, respectively.

TABLE 19
Thermal Stability by Cone & Plate Rheology: 48RV @ 270° C.

| | Complex Viscosity |
|---|---|
| Time (s) | (Pa · s) |
| 10 | 1.14E+03 |
| 58 | 1.12E+03 |
| 202 | 1.14E+03 |
| 394 | 1.17E+03 |
| 538 | 1.20E+03 |
| 682 | 1.25E+03 |
| 826 | 1.32E+03 |
| 874 | 1.35E+03 |
| 1067 | 1.51E+03 |
| 1163 | 1.60E+03 |
| 1210 | 1.67E+03 |
| 1258 | 1.72E+03 |
| 1352 | 1.87E+03 |
| 1399 | 1.95E+03 |
| 1446 | 2.05E+03 |
| 1538 | 2.27E+03 |
| 1631 | 2.55E+03 |
| 1680 | 2.71E+03 |
| 1728 | 2.89E+03 |
| 1776 | 3.10E+03 |

TABLE 20
Thermal Stability by Cone & Plate Rheology: 80RV @ 270° C.

| | Complex Viscosity |
|---|---|
| Time (s) | (Pa · s) |
| 11 | 1.82E+03 |
| 107 | 1.85E+03 |
| 299 | 1.82E+03 |
| 538 | 1.81E+03 |
| 635 | 1.82E+03 |
| 827 | 1.87E+03 |
| 923 | 1.93E+03 |
| 1019 | 2.00E+03 |
| 1211 | 2.24E+03 |
| 1307 | 2.41E+03 |
| 1403 | 2.62E+03 |
| 1547 | 3.05E+03 |
| 1643 | 3.44E+03 |
| 1739 | 3.91E+03 |
| 1785 | 4.18E+03 |

TABLE 21
Thermal Stability by Cone & Plate Rheology: 240RV @ 270° C.

| | Complex Viscosity |
|---|---|
| Time (s) | (Pa · s) |
| 10 | 2.76E+03 |
| 106 | 2.59E+03 |
| 202 | 2.50E+03 |
| 346 | 2.46E+03 |
| 442 | 2.46E+03 |
| 539 | 2.48E+03 |
| 634 | 2.52E+03 |
| 731 | 2.59E+03 |
| 826 | 2.69E+03 |
| 923 | 2.83E+03 |
| 1018 | 3.02E+03 |
| 1115 | 3.26E+03 |
| 1210 | 3.56E+03 |
| 1307 | 3.96E+03 |
| 1355 | 4.19E+03 |
| 1402 | 4.46E+03 |
| 1499 | 5.06E+03 |
| 1594 | .81E+03 |
| 1691 | 6.71E+03 |
| 1739 | 7.22E+03 |
| 1787 | 7.80E+03 |

As can be seen in Table 19, after 1000 seconds, the complex viscosity of the material increased. Again, without being bound to any particular theory, it is believed that crosslinking of the polyamide via the functional group of the impact modifier is enhanced at this point, thus increasing viscosity of the material.

### Example 12

### Determination of Coiling Strain

Coiling strain must be less than yield strain of the product at a selected temperature. Coiling strain is calculated as outer diameter of pipe/inner diameter of coil. For instance, if the coil diameter is 75″ and outer diameter of the pipe is 3.5″, then coiling strain is 3.5/75*100, or 4.6%. This strain must be less than yield strain of the polymer composition in order to prevent a permanent memory being imparted to the pipe and problems when uncoiling is performed.

The coiling force required to coil a 3″ SDR11 pipe of a composition of Example 1 in coils of a diameter from 70-90″ are listed below in Table 22.

TABLE 22

| | | | Uncoiling | |
|---|---|---|---|---|
| | | | Force Fully | |
| | Power, | Torque, | Coiled End, | Force at |
| Methodology | hp | Ft-lb | lb | Guide, lb |
| CAE Analysis | 0.09 | 804 | 525 | 305 |
| CAE Analysis- | 0.08 | 687 | 440 | 260 |
| Jung | | | | |
| M/EI = (1/R) - | 0.30 | 2,632 | 871 | 283 |
| hand | | | | |
| calculation | | | | |
| Max coiler | 1.57 | 13,972 | 4543 | 1,484 |
| power setting | | | | |
| of 28% (0.28 × | | | | |
| 4.19 kW) - | | | | |
| only a | | | | |
| fraction of | | | | |
| this power is | | | | |
| utilized | | | | |

A 3″ SDR11 pipes prepared from a composition of Example 1 had an uncoiling force which varied from 440-4543 lb, most times from 440-900 lb. This is an important aspect to consider for safe installation.

### Example 13

### Abrasion Resistance of Pipes

It is important for pipes and/or conduits to have a good abrasion resistance to minimize wear of pipe walls when exposed to fluids containing abrasive particles such as sand, minerals, etc., and thereby improve the safety factor of pipelines. Pipes prepared from a composition of Example 1 in accordance with the present invention had significantly better abrasion resistance as compared HDPE pipes. Under similar test conditions, it was found that the pipe of the present invention had 25× better abrasion resistance as compared to the HDPE pipe. More specifically, under similar test conditions, a pipe of the present invention showed a wear of 0.005 mg as compared to 0.134 mg in the HDPE pipe. Details of the test method used are shown in Table 23.

TABLE 23

| Method | ASTM 4060 | |
|---|---|---|
| | Standard Test Method for Abrasion Resistance | |
| | of Organic Coatings by the Taber Abraser | |
| Instrument | Taber Abraser | |
| Specimen | type | 4″ disc |
| | conditioning | 40 hrs, 23°/50% RH |
| | other preparation | cut from plaque |
| Parameters | wheel type | CS-10 |
| | abrasion cycles | 1000 |

Results for the pipe of the present invention are shown in Table 24.

TABLE 24

| | | mass after | Wear Index |
|---|---|---|---|
| Replicate | initial mass g | 1000 cycle g | mg |
| 1 | 26.835 | 26.834 | 0.001 |
| 2 | 26.586 | 26.581 | 0.005 |
| 3 | 26.664 | 26.656 | 0.008 |
| 4 | 26.726 | 26.718 | 0.008 |
| 5 | 26.999 | 26.998 | 0.001 |
| Mean | 26.762 | 26.757 | 0.005 |
| Std Dev | 0.161 | 0.163 | 0.004 |

Results for the HDPE pipe are shown in Table 25.

TABLE 25

| | | mass after | Wear Index |
|---|---|---|---|
| Replicate | initial mass g | 1000 cycle g | mg |
| 1 | 23.650 | 23.490 | 0.160 |
| 2 | 23.480 | 23.390 | 0.090 |
| 3 | 23.250 | 23.060 | 0.190 |
| 4 | 23.280 | 23.120 | 0.160 |
| 5 | 23.220 | 23.150 | 0.070 |
| Mean | 23.376 | 23.242 | 0.134 |
| Std Dev | 0.184 | 0.187 | 0.051 |

### Example 14

### Transition Fittings

Compositions of Example 1 were also demonstrated to make effective transition fittings which are used to join polyamide pipes to metal pipes or fittings. These are essential fittings to be able to make piping systems work. The following tests were performed and proved the viability of these fittings.

Hydrostatic quick burst test: Two transition fittings made from a composition of Example 1 were butt fused, and subjected to a hydrostatic leak test. The same samples were then subjected to a quick burst pressure testing by employing a pressure ramp rate of 23 psi/sec, and achieved a burst stress of 7000 psi. The failure did not happen in either the butt fusion or the transition joints, which ensured that transition fittings were acceptable.

Thermal cycle test: Samples were constructed of 2 butt fused transition fittings prepared from a composition of Example 1. Each sample was cycled 10 times from 140° F. to −20° F., and tested for leaks at 5 psig and 100 psig, respectively. No leaks were observed and fittings deemed suitable for use. Results are shown in Table 26.

TABLE 26

| °Sample # | Temperature (° F.) | Leak @ 5 psig | Leak @ 100 psig |
|---|---|---|---|
| 5, 6, 7 | 70 | No Leak, Pass | No Leak, Pass |
| 5, 6, 7 | 140** | No Leak, Pass | No Leak, Pass |
| 5, 6, 7 | −20** | No Leak, Pass | No Leak, Pass |

Thermal Cycle leak test data is shown for 6 joints

Hydrostatic leak test: Two transition fittings made from a composition of Example 1 were butt fused and then pressurized to 1.5× maximum allowable operating pressure and checked for leaks. The pressure was not allowed to drop below this pressure for 5 minutes. No leaks in the joint were detected and fittings were deemed acceptable. A 3″ SDR11 pipe was subjected to 675 psig and passed all the requirements.

Tensile pull test: Butt fused transition fittings of a composition of Example 1 were subjected to tensile pull test following the protocol set by ASTM D2513 and ASTM F1973 standards, where sections of pipe exceeding 5× OD of pipe were pulled to 105% and 125% of its original length, and then subjected to 5 psig and 100 psig pressure, respectively. No leaks were detected and fittings deemed good for service in the field. Table 27 summarizes these results.

TABLE 27
Tensile Pull Data for two Transition Joints

| Max | Max | | Leak test at | Leak test at |
|---|---|---|---|---|
| Load | Elongation | Tensile Pull | 5/100 psig @ 5% | 5/100 psig @ |
| (lbs) | Reached | Speed (in/min) | elongation | 25% elongation |
| 15,625 | 30% | .2 | Pass, No Leaks | Pass, No Leaks |

Bend back and Impact test: Different butt fusion parameters were utilized and the transition fitting samples of compositions of Example 1 were subjected to hammer impact and bend back tests to determine if the butt fusion between the plastic end of a transition fitting and a plastic pipe fused well. Table 28 shows sample 8, which was fused using the butt fusion parameters of Example 8 passed all conditions.

TABLE 28
Bend Back and Hammer Impact Tests Performed on PA-66
Pipe Butt Fusion Joints

| Sample # | # of Strips | Test Performed | Strips That Failed |
|---|---|---|---|
| 2 | 4 | Bend Back | 3/4 |
| 2 | 4 | Hammer Impact | 4/4 |
| 3 | 4 | Bend Back | 3/4 |
| 3 | 4 | Hammer Impact | 4/4 |
| 8 | 4 | Bend Back | 0/4 |
| 8 | 4 | Hammer Impact | 0/4 |

### Example 15

### Effects of SDR on Burst Stress

Experiments have demonstrated that articles made with a composition of Example 1 in accordance with the process of the present invention exhibited a significant improvement in burst stress as compared to unprocessed polymer and when the SDR ratio changed from 11 to 7. SDR7 showed a burst stress of 9269 psi, SDR9 showed a burst stress of 8846 psi, and SDR11 shows a burst stress of 8425 psi. Table 29 shows improvement in properties.

TABLE 29

| | | % Improvement Vs Virgin |
|---|---|---|
| SDR | Quick Burst stress (psi) | Polymer |
| 7 | 9269 | 36 |
| 9 | 8846 | 30 |
| 11 | 8425 | 24 |

Tables 30 and 31 provide a comparison of quick burst stresses of 3″ SDR9 and 3″ SDR7 pipe testing without water saturation, respectively.

TABLE 30

| | | | | | Burst |
|---|---|---|---|---|---|
| Sample | Size/ | Min Wall | Outside D | Quick Burst | Stress |
| Time | SDR | thickness (in) | (in) | Pressure (psi) | (psi) |
| 1 | 3 DR9 | 0.393 | 3.492 | 1970 | 8752 |
| 2 | 3 DR9 | 0.385 | 3.492 | 1983 | 8993 |
| 3 | 3 DR9 | 0.38 | 3.493 | 1920 | 8824 |
| 4 | 3 DR9 | 0.379 | 3.493 | 1913 | 8815 |
| | | | Average | 1947 | 8846 |

TABLE 31

| | | | | | Burst |
|---|---|---|---|---|---|
| Sample | Size/ | Min Wall | Outside D | Quick Burst | Stress |
| Time | SDR | thickness (in) | (in) | Pressure (psi) | (psi) |
| 1 | 3 DR7 | 0.484 | 3.511 | 2599 | 9427 |
| 2 | 3 DR7 | 0.474 | 3.487 | 2550 | 9380 |
| 3 | 3 DR7 | 0.486 | 3.486 | 2599 | 9321 |
| 4 | 3 DR7 | 0.501 | 3.49 | 2569 | 8948 |
| | | | Average | 2579 | 9269 |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

1. A composition comprising:
(a) 60 to 99.9% by weight of a polyamide; and
(b) 0.5 to 40% by weight of an impact modifier containing maleic anhydride or a functional equivalent thereof;
wherein the composition has a moisture level less than the equilibrium moisture content of the polyamide.

2. (canceled)

3. The composition of claim 1 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

4. The composition of claim 3 which does not further comprise a plasticizer.

5. The composition of claim 3 wherein the polyamide is nylon 6,6 having an initial relative viscosity of at least 35.

6. The composition of claim 5 wherein the moisture level is less than 0.15% by weight.

7. (canceled)

8. The composition of claim 3 wherein the moisture level is less than 0.05% by weight.

9. The composition of claim 3 whereon the polyamide is nylon 6,6, having an initial relative viscosity of at least 80.

10. The composition of claim 9 wherein the moisture level is 0.03% by weight or less.

11. The composition of claim 3 wherein the polyamide is nylon 6,6 having an initial relative viscosity of at least 240.

12. The composition of claim 11 wherein the moisture level is 0.005% by weight or less.

13. The composition of claim 1 wherein the impact modifier has an effective maleic anhydride level of less than 1% by weight.

14. The composition of claim 13 wherein the impact modifier has an effective maleic anhydride level of 0.044 to 0.11% by weight.

15. The composition of claim 1 wherein the impact modifier comprises a maleated ethylene propylene diene rubber.

16. (canceled)

17. (canceled)

18. (canceled)

19. An article of manufacture comprising at least one component formed from the composition of claim 1.

20. (canceled)

21. The article of manufacture of claim 19, wherein the component is an extruded component.

22. A pipe comprising at least one component formed from the composition of claim 1.

23. An extrudable thermoplastic resin having a melt strength of at least 0.08N, said thermoplastic resin comprising:
(a) 60 to 99.9% by weight of a polyamide; and
(b) 0.5 to 40% by weight of an impact modifier.

24. The extrudable thermoplastic resin of claim 23 wherein the melt strength is at least 0.12N.

25. The extrudable thermoplastic resin of claim 23 wherein the moisture level of the resin is less than the equilibrium moisture content of the polyamide.

26. The extrudable thermoplastic resin of claim 23 wherein the polyamide is a high tensile strength polyamide.

27. The extrudable thermoplastic resin of claim 26 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

28. The extrudable thermoplastic resin of claim 23, wherein said impact modifier comprises an elastomer selected from the group consisting of ethylene, propylene, octene with alkyl acrylate or alkyl methacrylate, styrene-butadiene two-block copolymers, styrene-butadiene-styrene three block copolymers, and copolymers or terpolymers of ethylene, octane, propylene and/or diene.

29. The extrudable thermoplastic resin of claim 23 wherein the impact modifier further comprises a functional group selected from the group consisting of carboxylic acid groups, carboxylic anhydride groups, carboxamide groups, carboximide groups, amino groups, hydroxyl groups, epoxy groups, urethane groups and oxazoline groups.

30. An extrudable thermoplastic resin comprising:
(a) 60 to 99.9% by weight of a polyamide; and
(b) 0.5 to 40% by weight of an impact modifier,
wherein said extrudable thermoplastic resin is capable of forming a pipe.

31. The extrudable thermoplastic resin of claim 30 wherein said pipe is used for oil and gas pipeline, for transporting hydrocarbon containing fluids, water transportation in fracking, water systems for residential and commercial facilities and/or transport of compatible chemicals.

32. The extrudable thermoplastic resin of claim 30 wherein said pipe has a quick burst stress of at least 6000 psi, quick burst stress upon water saturation of at least 4000 psi, a long term hydrostatic strength (LTHS) of at least 1000 psi at 82° C., and/or a LTHS of at least 2000 psi at 23° C.

33. The extrudable thermoplastic resin of claim 30 wherein said impact modifier has an unsaturated carboxylic anhydride content in the range from 0.2 to 0.6% by weight.

34. The extrudable thermoplastic resin of claim 30 wherein the resin has a moisture level less than the equilibrium moisture content of the polyamide.

35. The extrudable thermoplastic resin of claim 30 further comprising from 0.5 to 25% by weight silicon based additive.

36. The extrudable thermoplastic resin of claim 35 wherein the silicon based additive comprises an ultrahigh molecular weight siloxane polymer and a binding agent.

37. The extrudable thermoplastic resin of claim 36 wherein the ultrahigh molecular weight siloxane polymer is unfunctionalized and non-reactive with the polyamide.

38. An extrudable thermoplastic resin comprising a polyamide and having a shear viscosity from 500 to 3000 Pa-sec when tested at a shear rate of 50 sec⁻¹ and a melt temperature of 270-280° C., and a moisture level from 0.03 to 0.15%.

39. The extrudable thermoplastic resin of claim 38 wherein the resin has a moisture level less than the equilibrium moisture content of the polyamide.

40. The extrudable thermoplastic resin of claim 38 wherein the polyamide is a high tensile strength polyamide.

41. The extrudable thermoplastic resin of claim 40 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

42. A pipe extruded from the composition of claim 1.

43. A pipe extruded from the extrudable thermoplastic resin of claim 23.

44. A pipe extruded from the extrudable thermoplastic resin of claim 30.

45. A pipe extruded from the extrudable thermoplastic resin of claim 38.

46. An extruded thermoplastic pipe comprising a polyamide and having a quick burst stress with water saturation of at least 4000 psi when tested at 23° C.

47. The extruded thermoplastic pipe of claim 46 wherein the quick burst stress without saturating the pipe is at least 6000 psi when tested at 23° C.

48. The pipe of claim 46 wherein the quick burst stress is in the range of 4000 to 12,000 psi when tested at 23° C.

49. The extruded thermoplastic pipe of claim 46 having a diameter to wall thickness ratio ranging from 5 to 32.

50. The extruded thermoplastic pipe of claim 46 wherein the polyamide is a high tensile strength polyamide.

51. The extruded thermoplastic pipe of claim 50 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

52. An extruded thermoplastic pipe comprising a polyamide and having a LTHS of at least 1000 psi at 82° C.

53. The extruded thermoplastic pipe of claim 52 wherein the polyamide is a high tensile strength polyamide.

54. The extruded thermoplastic pipe of claim 53 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

55. An extruded thermoplastic pipe comprising a polyamide having a LTHS of at least 2000 psi at 23° C.

56. The extruded thermoplastic pipe of claim 55 wherein the polyamide is a high tensile strength polyamide.

57. The extruded thermoplastic pipe of claim 56 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

58. An extruded thermoplastic pipe comprising a polyamide and having a shear relative viscosity below 1000 Pa-sec when tested at a shear rate of 50 sec⁻¹ and a melt temperature of 270-280° C., and a moisture level from 0.03 to 0.15%.

59. The extruded thermoplastic pipe of claim 58 wherein the polyamide is a high tensile strength polyamide.

60. The extruded thermoplastic pipe of claim 59 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

61. An extruded thermoplastic pipe comprising a polyamide and having a standard dimension ratio (SDR) from about 3 to about 30.

62. The extruded thermoplastic pipe of claim 61 wherein the standard dimension ratio (SDR) is from about 7 to about 12.

63. The extruded thermoplastic pipe of claim 61 wherein the polyamide is a high tensile strength polyamide.

64. The extruded thermoplastic pipe of claim 63 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

65. An extruded thermoplastic pipe comprising a polyamide and made with a swell ratio ranging from 0.5 to 2.5.

66. The extruded thermoplastic pipe of claim 65 wherein the swell ratio ranges from 0.7 to 1.3.

67. The extruded thermoplastic pipe of claim 65 wherein the swell ratio ranges from 0.7 to 1.2.

68. The extruded thermoplastic pipe of claim 65 wherein the polyamide is a high tensile strength polyamide.

69. The extruded thermoplastic pipe of claim 65 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

70. An extruded thermoplastic pipe comprising a polyamide and made in a die having an orientation ratio ranging from 2 to 30.

71. The extruded thermoplastic pipe of claim 70 wherein the orientation ratio ranges from 5 to 25.

72. The extruded thermoplastic pipe of claim 70 wherein the orientation ratio ranges from 5 to 21.

73. The extruded thermoplastic pipe of claim 70 wherein the polyamide is a high tensile strength polyamide.

74. The extruded thermoplastic pipe of claim 70 wherein the polyamide is selected from the group consisting of nylon 6,6; nylon 6; nylon 4,6; nylon 6,12; nylon 6,10; nylon 6T; nylon 6I; nylon 9T; nylon DT; nylon DI; nylon D6; and nylon 7; and/or combinations thereof.

75. The pipe of claim 42, wherein at least a portion of an outer surface of the pipe is covered by a reinforcing material.

76. The pipe of claim 75 wherein the reinforcing material is selected from a group consisting of glass fiber, carbon fiber, nylon fiber, polyester fibers and steel wire and combinations thereof.

77. The pipe of claim 42, wherein at least a portion of the outer surface of the pipe is bonded with a second thermoplastic material.

78. The pipe of claim 77 wherein the second thermoplastic material is selected from a group consisting of high density polyethylene (HDPE), polyamide, polypropylene, polyphenylene sulfide, polyetheretherketone and rubber, and combinations thereof.

79. The pipe of claim 42 wherein at least a portion of an outer surface of the pipe is covered by an unbonded second thermoplastic material.

80. The pipe of claim 79 wherein the second thermoplastic material is selected from a group consisting of high density polyethylene (HDPE), polyamide, polypropylene, polyphenylene sulfide, polyetheretherketone and rubber, and combinations thereof.

81. The pipe of claim 42 wherein at least a portion of an inner surface of the pipe is bonded with a second thermoplastic material.

82. The pipe of claim 81 wherein the second thermoplastic material is selected from a group consisting of high density polyethylene (HDPE), polyamide, polypropylene, polyphenylene sulfide, polyetheretherketone and rubber, combinations thereof.

83. The pipe of claim 42 wherein at least a portion of an inner surface of the pipe is lined with an unbonded second thermoplastic material.

84. The pipe of claim 83 wherein the second thermoplastic material is selected from a group consisting of high density polyethylene (HDPE), polyamide, polypropylene, polyphenylene sulfide, polyetheretherketone and rubber, and combinations thereof.

85. The pipe of any of claim 42 further comprising a silicone based additive in the range from about 0.01 to about 25 by weight percent.

86. The pipe of claim 85 wherein the silicone based additive comprises an ultrahigh molecular weight siloxane polymer.

87. The pipe of claim 86 wherein the ultrahigh molecular weight siloxane polymer is unfunctionalized and non-reactive with the thermoplastic pipe.

88. The pipe of claim 42 which is capable of being butt fused with another thermoplastic pipe of the same composition.

89. The pipe of claim 42 which is capable of being coupled with another pipe through electrofusion, compression fitting or transition fitting.

90. The pipe of claim 42 further comprising a copolymer selected from nylon 6; nylon 4,6; nylon 6,12; nylon 6,10; nylon 6T; nylon 6I; nylon 9T; nylon DT; nylon DI; nylon D6; nylon 7; nylon 11; and nylon 12, and combinations thereof.

91. (canceled)

92. An extruded thermoplastic pipe comprising a polyamide which maintains its ovality and can be coiled for transport and storage.

93. The extruded thermoplastic pipe of claim 92 with a coiling strain from about 1% to about 30%.

94. The extruded thermoplastic pipe of claim 92 with a coiling strain from about 3% to about 6%.

95.-130. (canceled)
